(19) United States
(12) Patent Application Publication
(10) Pub. No.: US 2010/0296141 A1
(43) Pub. Date: Nov. 25, 2010

(54) IMAGE READING APPARATUS

(75) Inventor: Hiroyuki MARUYAMA, Ishikawa (JP)

Correspondence Address: LOWE HAUPTMAN HAM & BERNER, LLP, 1700 DIAGONAL ROAD, SUITE 300, ALEXANDRIA, VA, 22314, US

(73) Assignee: PFU LIMITED, Ishikawa (JP)

(21) Appl. No.: 12/708,954

(22) Filed: Feb. 19, 2010

(30) Foreign Application Priority Data
May 25, 2009 (JP) 2009-125757

(51) Int. Cl. H04N 1/48

(52) U.S. Cl. 358/509

(57) ABSTRACT

An image reading apparatus generates color image data from an image on a medium, based on R-color, G-color, and B-color data, and includes: an unit that irradiates light to the medium; an unit that includes R-color, B-color, and G-color imaging members, which each output the R-color, G-color, or B-color data respectively, based on received light from the medium; a light source that irradiates to the medium first light of a first visible wavelength range different from R-color; and a unit that generates fluorescent image data of a fluorescent region contained in the image, based on predetermined color data corresponding to second light of a second visible wavelength range different from the first visible wavelength range, the second light being generated by the fluorescent region when the light source is turned on and the fluorescent region receives the first light.

### CROSS-REFERENCE TO RELATED APPLICATIONS

This application is based upon and claims the benefit of priority from Japanese Patent Application No. 2009-125757, filed on May 25, 2009, the entire contents of which are incorporated herein by reference.

### BACKGROUND OF THE INVENTION

1. Field of the Invention

The present invention relates to an image reading apparatus, and in particular, to an image reading apparatus that includes an imaging unit having imaging members that respectively output R-color image data, G-color image data, and B-color image data.

2. Description of the Related Art

Conventionally, a technique for identifying a fluorescent region contained in an image formed on a medium to be read is known. For example, in Japanese Patent No. 3344771, a color image processing apparatus is disclosed, which identifies a fluorescent color if: an r signal is equal to or larger than a first threshold or a g signal is equal to or larger than a second threshold; and a b signal is equal to or smaller than a third threshold (where the first and second thresholds>the third threshold), from among color signals of a plurality of colors read from a color original.

In the identification method disclosed in Japanese Patent No. 3344771, because the threshold is set between the value of the color signal of the non-fluorescent color and the value of the color signal of the fluorescent color, it may not be possible to sufficiently increase sensitivity of the identification of the fluorescent color. Furthermore, the sensitivity of the identification may be reduced depending on the density of the background or the like, and proper identification of the fluorescent color may not be possible.

### SUMMARY OF THE INVENTION

According to an aspect of the invention, an image reading apparatus generates color image data from an image on a medium to be read, based on R-color data, G-color data, and B-color data. The image reading apparatus includes: an irradiating unit that irradiates light to the medium; an imaging unit that includes an R-color imaging member that outputs the R-color data based on received light from the medium to which the light has been irradiated by the irradiating unit, a G-color imaging member that outputs the G-color data based on the received light, and a B-color imaging member that outputs the B-color data based on the received light; a predetermined light source that irradiates to the medium first light of a first visible wavelength range different from R-color; and a fluorescent-image-data generating unit that generates fluorescent image data of a fluorescent region contained in the image, based on predetermined color data corresponding to second light of a second visible wavelength range different from the first visible wavelength range, the second light being generated by the fluorescent region when the predetermined light source is turned on and the fluorescent region receives the first light from the predetermined light source.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a diagram of a general configuration of an image reading apparatus according to a first embodiment of the present invention;

FIG. 2 is a diagram illustrating relative spectral characteristics of water-based fluorescent pens when an LED that emits blue light is lighting in the image reading apparatus according to the first embodiment of the present invention;

FIG. 3 is a diagram illustrating relative spectral characteristics of water-based fluorescent pens when an LED that emits green light is lighting in the image reading apparatus according to the first embodiment of the present invention;

FIG. 4 is a diagram illustrating relative spectral characteristics of water-based fluorescent pens when an LED that emits red light is lighting in the image reading apparatus according to the first embodiment of the present invention;

FIG. 5 is a diagram illustrating filter characteristics of an image sensor of the image reading apparatus according to the first embodiment of the present invention;

FIG. 6 is a diagram illustrating results obtained by multiplying the relative spectral characteristics at the time of irradiation with a blue LED by each color filter characteristic of the image sensor at each wavelength in the image reading apparatus according to the first embodiment of the present invention;

FIG. 7 is a diagram illustrating outputs from each color filter with respect to each detection target irradiated with the blue LED in the image reading apparatus according to the first embodiment of the present invention;

FIG. 8 is a diagram illustrating a state in which fluorescence in red wavelengths, which is generated by irradiating a fluorescent region drawn with a pink fluorescent pen with a green LED, enters a red sensor in the image reading apparatus according to the first embodiment of the present invention;

FIG. 9 is a block diagram of a main configuration of the image reading apparatus according to the first embodiment of the present invention;

FIG. 10 is a diagram illustrating an image processing method performed when a red LED is turned on in the image reading apparatus according to the first embodiment of the present invention;

FIG. 11 is a diagram illustrating an image processing method performed when the green LED is turned on in the image reading apparatus according to the first embodiment of the present invention;

FIG. 12 is a diagram illustrating an image processing method performed when the blue LED is turned on in the image reading apparatus according to the first embodiment of the present invention;

FIG. 13 is a diagram illustrating results obtained by multiplying each spectrum of a yellow fluorescent pen and a white background by a green filter characteristic at each wavelength in the image reading apparatus according to the first embodiment of the present invention;

FIG. 14 is a diagram illustrating outputs from a green sensor with respect to incident light from the yellow fluorescent pen and the white background in the image reading apparatus according to the first embodiment of the present invention;

FIG. 15 is a diagram illustrating spectral characteristics of each region, which are obtained by fluorescence identification performed by the image reading apparatus according to the first embodiment of the present invention;

FIG. 16 illustrates an example of a result of identification of a fluorescent region by the fluorescence identification performed by the image reading apparatus according to the first embodiment of the present invention;

FIG. 17 is a diagram illustrating a method for capturing a normal image by an image reading apparatus according to a second embodiment of the present invention;

FIG. 18 is a diagram illustrating a method for capturing an image of a fluorescent region by lighting a green LED in the image reading apparatus according to the second embodiment of the present invention;

FIG. 19 is a diagram illustrating a method for capturing an image of a fluorescent region by lighting a blue LED in the image reading apparatus according to the second embodiment of the present invention;

FIG. 20 is a diagram of a general configuration of an image reading apparatus according to a first modified example of the second embodiment of the present invention;

FIG. 21 is a diagram for explaining occurrence of jitter in an image reading apparatus according to a second modified example of the second embodiment of the present invention;

FIG. 22 is a diagram for explaining suppression of jitter by lengthening an exposure time of a white light source in the image reading apparatus according to the second modified example of the second embodiment of the present invention;

FIG. 23 is a diagram illustrating effects obtained when light sources are switched frame-sequentially instead of line-sequentially in an image reading apparatus according to a third embodiment of the present invention;

FIGS. 24A and 24B are schematic diagrams for explaining high-speed image reading for reading a fluorescent region by the image reading apparatus according to the third embodiment of the present invention;

FIG. 25 is a block diagram of a main configuration of an image reading apparatus according to a fourth embodiment of the present invention;

FIG. 26 is a diagram for explaining a control to increase an amount of luminescence of a green LED of the image reading apparatus according to the fourth embodiment of the present invention;

FIG. 27 is a diagram for explaining a control to increase an amplifier gain of an image input unit of the image reading apparatus according to the fourth embodiment of the present invention;

FIG. 28 is a diagram illustrating a method for setting a white reference for a normal image by an image reading apparatus according to a fifth embodiment of the present invention;

FIG. 29 is a diagram illustrating a method for setting a fluorescence reference for a green LED by the image reading apparatus according to the fifth embodiment of the present invention;

FIG. 30 is a diagram illustrating a method for setting a fluorescence reference for a blue LED by the image reading apparatus according to the fifth embodiment;

FIG. 31 illustrates an example of an image containing a fluorescent region that cannot be identified accurately by a conventional technique;

FIG. 32 is a diagram illustrating a spectral characteristic of each region of the image containing the fluorescent region that cannot be identified accurately by the conventional technique;

FIG. 33 illustrates an example of a result of identification of the fluorescent region by the conventional technique;

FIG. 34 is a diagram for explaining occurrence of false color in conventional image reading; and

FIG. 35 is a diagram for explaining an image generated by a conventional image reading apparatus that reads an image by using a white light source and a three-line sensor.

### DETAILED DESCRIPTION OF THE PREFERRED EMBODIMENTS

Exemplary embodiments of an image reading apparatus according to the present invention will be explained in detail below with reference to the accompanying drawings. The present invention is not limited by the following embodiments. In addition, constituent elements in the following embodiments contain those that can be easily thought of by persons skilled in the art or those substantially equivalent thereto.

### First Embodiment

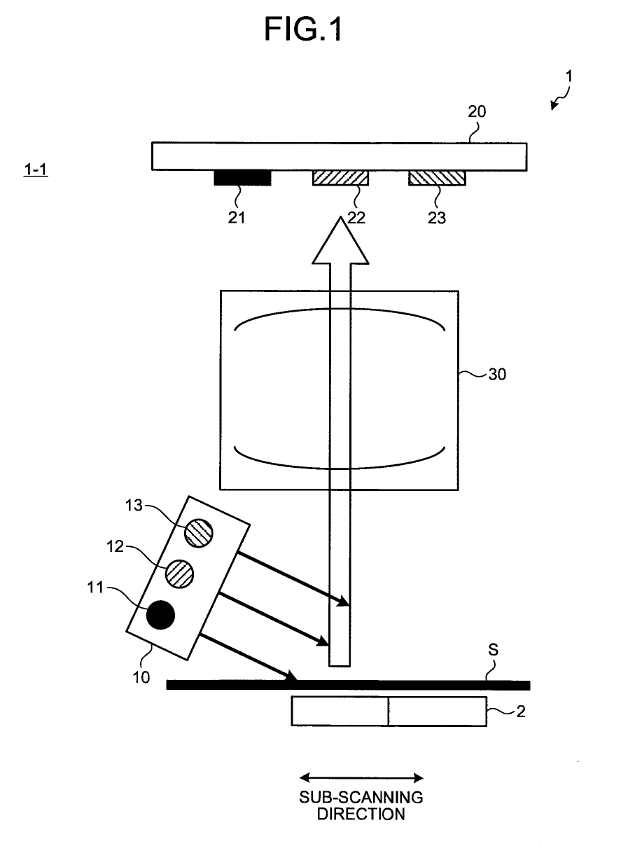

A first embodiment of the present invention will be described with reference to FIGS. 1 to 16. The present embodiment relates to an image reading apparatus that includes an imaging unit having imaging members that respectively output R-color image data, G-color image data, and B-color image data. FIG. 1 is a schematic diagram of a general configuration of the image reading apparatus according to the first embodiment of the present invention.

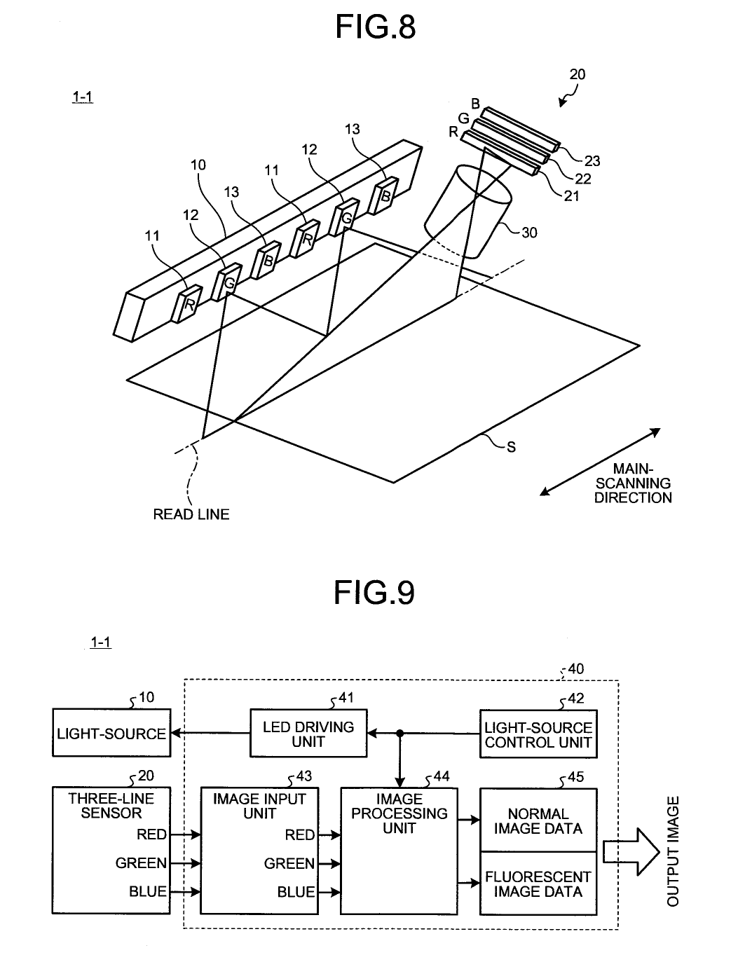

In FIG. 1, a code 1-1 denotes the image reading apparatus of the present embodiment. The image reading apparatus 1-1 includes an image reading unit 1, a reference plate 2, and a conveying device not illustrated. The image reading unit 1 optically scans an image on a sheet original S being conveyed, and reads the image as image data by converting the read image to an electrical signal. The image reading unit 1 includes a light source 10, a three-line sensor 20, and a lens 30. The light source 10 is an irradiating unit that irradiates the original S as a read target medium with light in the visible region, and is a three-color LED array having LEDs in three colors, i.e., a red LED 11, a green LED 12, and a blue LED 13. As illustrated in FIG. 8, in the light source 10, the red LED 11, the green LED 12, and the blue LED 13 are arranged in a line along a main-scanning direction. The red LED 11, the green LED 12, and the blue LED 13 are each able to be turned on solely to irradiate the original S with monochromatic light.

The lens 30 focuses reflected light from the original S or light emitted from the original S to form an image. Specifically, the lens 30 focuses the reflected light reflected by the original S upon irradiation with light from the light source 10 or focuses light emitted from the original S upon reception of light emitted from the light source 10 onto a light receiving surface of the three-line sensor 20 to form an image.

The three-line sensor 20 is, for example, a CCD (charge coupled device), in which a plurality of pixels receive light focused (entered) through the lens 30 and then convert the received light to an electrical signal to read an image. When light from the original S, e.g., light reflected by the original S upon irradiation with light from the light source 10 or fluorescence generated by the original S upon reception of light emitted from the light source 10, is converged by the lens 30 onto the light receiving surface of the three-line sensor 20 to form an image, each pixel of the three-line sensor 20 converts an amount of received light to an electrical signal and outputs the electrical signal. As illustrated in FIG. 1, the three-line sensor 20 includes three color line sensors having filters in colors different from each other. More specifically, the three-line sensor 20 includes a red sensor (R-color imaging member) 21 having a red filter, a green sensor (G-color imaging member) 22 having a green filter, and a blue sensor (B-color imaging member) 23 having a blue filter. The sensors 21, 22, and 23 for respective colors are arranged parallel to each other along a main-scanning direction. In FIG. 1, a depth direction in the figure corresponds to the main-scanning direction of the three-line sensor 20, and a left-to-right direction in the figure corresponds to a sub-scanning direction of the three-line sensor 20.

The reference plate 2 is located near a conveying path for the original S and arranged opposite the three-line sensor 20. The reference plate 2 is used for setting a white reference for image data correction. When the white reference is to be set, white light is applied to the reference plate 2 from the light source 10 (the red LED 11, the green LED 12, and the blue LED 13 are turned on simultaneously) while no original S is present at an image read target position. Accordingly, the white light emitted from the light source 10 is reflected by the reference plate 2 and the reflected light enters the three-line sensor 20. An output from each of the red sensor 21, the green sensor 22, and the blue sensor 23 at this time is set as a white reference of each of the sensors 21, 22, and 23.

The conveying device conveys the original S in a conveying direction that is the sub-scanning direction. The conveying device includes, for example, a driving roller that is driven by a motor and a driven roller that is pressed against the driving roller, and conveys the original S by holding the original S between the driving roller and the driven roller.

In a conventional image reading apparatus, when a three-color light source is employed, an image sensor is not provided with color filters, and, when the image sensor is provided with filters for three colors, a white light source is employed. In contrast, the image reading apparatus 1-1 of the present embodiment includes the three-line sensor 20 as an image sensor having the filters for three colors, and the three-color light source 10 that is able to emit light in three colors. Therefore, as described below, a fluorescent region generated on the original S can be identified with high sensitivity by a combination of a color of the light source and a color of the image sensor.

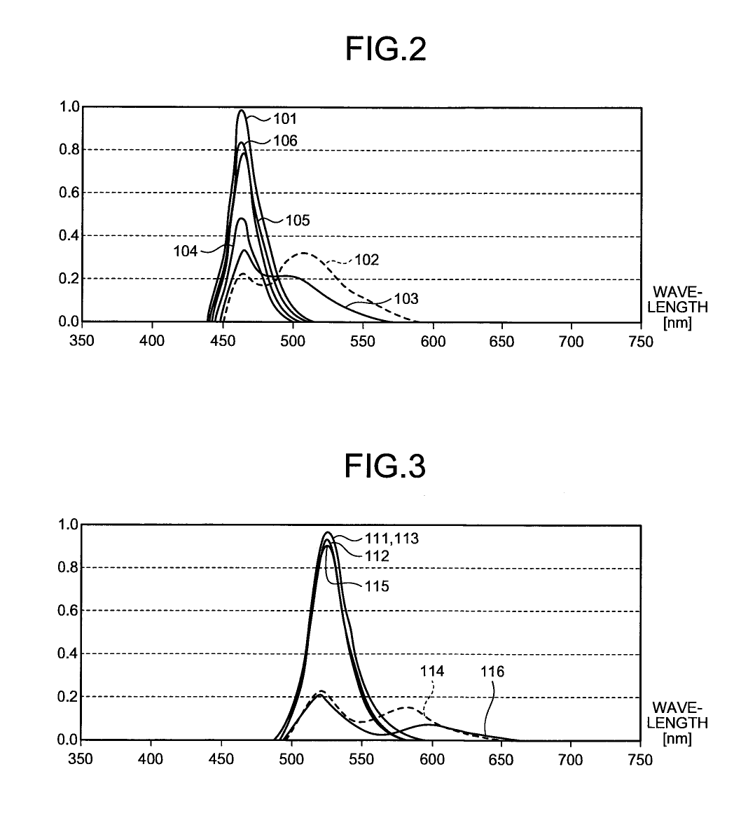

The inventor of the present invention has focused attention on spectral characteristics of fluorescent images (fluorescent dye) and made researches on relative spectral characteristics of fluorescent regions at the time of irradiation with monochromatic light, so that the inventor has obtained findings as described below. FIGS. 2 to 4 are diagrams illustrating relative spectral characteristics measured from an original that is a white recycled paper with an image (fluorescent image) that is drawn with a water-based fluorescent pen. Each of FIGS. 2 to 4 illustrates spectra of five color water-based fluorescent pens (yellow, green, pink, blue, and magenta) and a spectrum of the white recycled paper (white background). In each of FIGS. 2 to 4, a horizontal axis represents a wavelength (nm) and a vertical axis represents a spectral characteristic value.

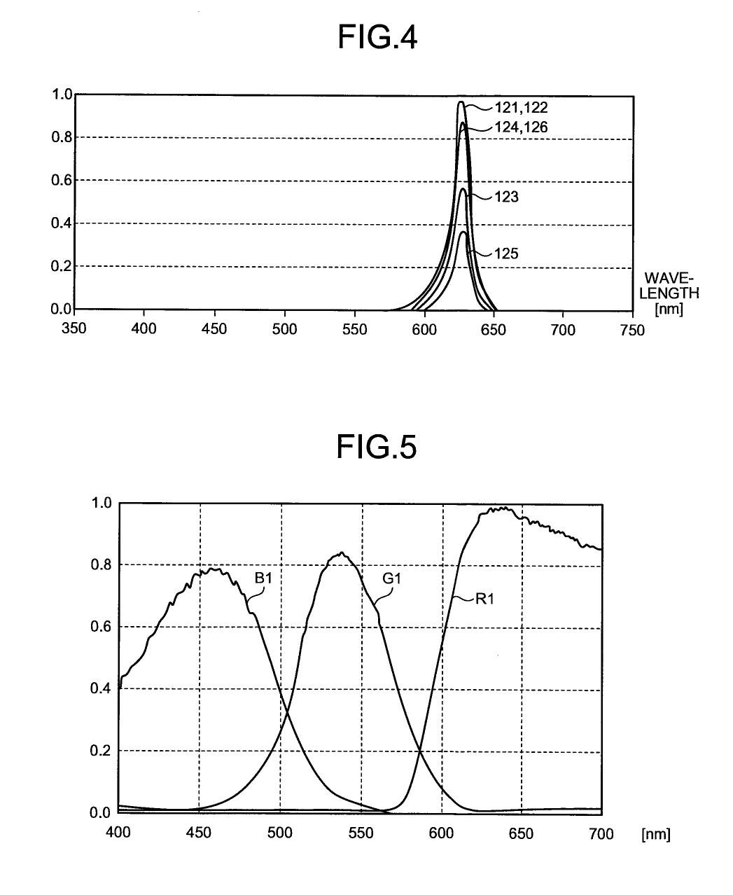

FIGS. 2, 3, and 4 are different from one another in terms of colors of the light sources that have applied monochromatic light. FIG. 2 is a diagram illustrating the relative spectral characteristics of the water-based fluorescent pens when the blue LED 13 that emits blue light (Blue) is lighting. FIG. 3 is a diagram illustrating the relative spectral characteristics of the water-based fluorescent pens when the green LED 12 that emits green light (Green) is lighting. FIG. 4 is a diagram illustrating the relative spectral characteristics of the water-based fluorescent pens when the red LED 11 that emits red light (Red) is lighting.

As illustrated in FIG. 2, the spectrum of the white background (code 101) at the time of irradiation with the blue LED 13 has a peak wavelength at around 465 nm. Because fluorescence is not generated by the white background, the spectrum 101 of the white background is substantially equal to a spectrum of the blue LED 13 as the light source.

Among the five color fluorescent pens, each peak wavelength of spectra of the pink fluorescent pen (code 104), the blue fluorescent pen (code 105), and the magenta fluorescent pen (code 106) is similar to the peak wavelength of the spectrum 101 of the white background, and does not contain other particular peak wavelengths. On the other hand, among the five color fluorescent pens, each spectrum of the yellow fluorescent pen (code 102) and the green fluorescent pen (code 103) has another peak at a different wavelength in addition to a peak at the wavelength similar to those of the white background and the other color fluorescent pens (pink, blue, and magenta). The other peak represents a peak of a fluorescent component. That is, when the blue light is applied, fluorescent regions drawn with the yellow fluorescent pen and the green fluorescent pen reflect the blue light, and at the same time, absorb a part of the blue light and then emit fluorescence at a wavelength longer than that of the blue light.

In each of the spectrum 102 of the yellow fluorescent pen and the spectrum 103 of the green fluorescent pen, the peak of the reflected light at around 465 nm is lowered and the other peak appears at around 500 nm because of the fluorescence. The fluorescent component with the peak at around 500 nm overlaps the green wavelength range. The fluorescent component of each of the yellow fluorescent pen and the green fluorescent pen is distributed over a longer wavelength range than the blue reflected light. Furthermore, in this wavelength range, the fluorescent component has a larger value than the white background. That is, if light in this wavelength range is selectively detected, then the fluorescent region (i.e., the fluorescent pen) can be identified with high sensitivity. Consequently, in the present embodiment, the yellow fluorescent region and the green fluorescent region are identified based on outputs from the green sensor 22 at the time of irradiation with the blue light.

As illustrated in FIG. 3, when the green LED 12 that emits green light is lighting, a spectrum of the white background (a code 111) has a peak wavelength at around 530 nm. The spectrum 111 of the white background is substantially equal to a spectrum of the green LED 12 as the light source. Among the five color fluorescent pens, each peak wavelength of spectra of the yellow fluorescent pen (a code 112), the green fluorescent pen (a code 113), and the blue fluorescent pen (a code 115) is similar to the peak wavelength of the spectrum 111 of the white background, and does not contain other particular peak wavelengths. In other words, upon irradiation with the green light, fluorescence is not generated by images drawn with the yellow fluorescent pen, the green fluorescent pen, and the blue fluorescent pen.

On the other hand, each spectrum of the pink fluorescent pen (a code 114) and the magenta fluorescent pen (a code 116) has another peak at a different wavelength in addition to a peak at the wavelength similar to those of the white background and the other color fluorescent pens (yellow, green, and blue). That is, when the green light is applied, fluorescent regions drawn with the pink fluorescent pen and the magenta fluorescent pen reflect the green light, and at the same time, absorb the green light and then emits fluorescence at a wavelength longer than that of the green light. In each of the spectrum 114 of the pink fluorescent pen and the spectrum 116 of the magenta fluorescent pen, the peak of the reflected light at around 530 nm is lowered and the other peak appears at a wavelength in a range from about 580 nm to about 600 nm because of the fluorescence. The fluorescent component with the peak at the wavelength in the range from 580 nm to 600 nm overlaps the red wavelength range. Furthermore, in this wavelength range, the fluorescent component has a larger value than the white background. Consequently, in the present embodiment, the pink fluorescent region and the magenta fluorescent region are identified based on outputs from the red sensor 21 at the time of irradiation with the green light.

As illustrated in FIG. 4, when the red LED 11 that emits red light is lighting, a spectrum of the white background (a code 121) has a peak wavelength at around 630 nm. A code 122 denotes a spectrum of the yellow fluorescent pen, a code 123 denotes a spectrum of the green fluorescent pen, a code 124 denotes a spectrum of the pink fluorescent pen, a code 125 denotes a spectrum of the blue fluorescent pen, and a code 126 denotes a spectrum of the magenta fluorescent pen. It can be found that fluorescence is not generated by any one of the fluorescent pens upon irradiation with the red light.

FIG. 5 is a diagram illustrating filter characteristics of the three-line sensor 20. The image reading apparatus 1-1 of the present embodiment includes the three-line sensor 20 having sensors that capture images based on light that has passed through filters in different colors, i.e., blue (B), green (G), and red (R). In FIG. 5, a code B1 represents a filter characteristic of the blue filter, a code G1 represents a filter characteristic of the green filter, and a code R1 represents a filter characteristic of the red filter. The blue sensor 23 has the blue filter and outputs B-color data as image data for blue (B-color). The green sensor 22 has the green filter and outputs G-color data as image data for green (G-color). The red sensor 21 has the red filter and outputs R-color data as image data for red (R-color).

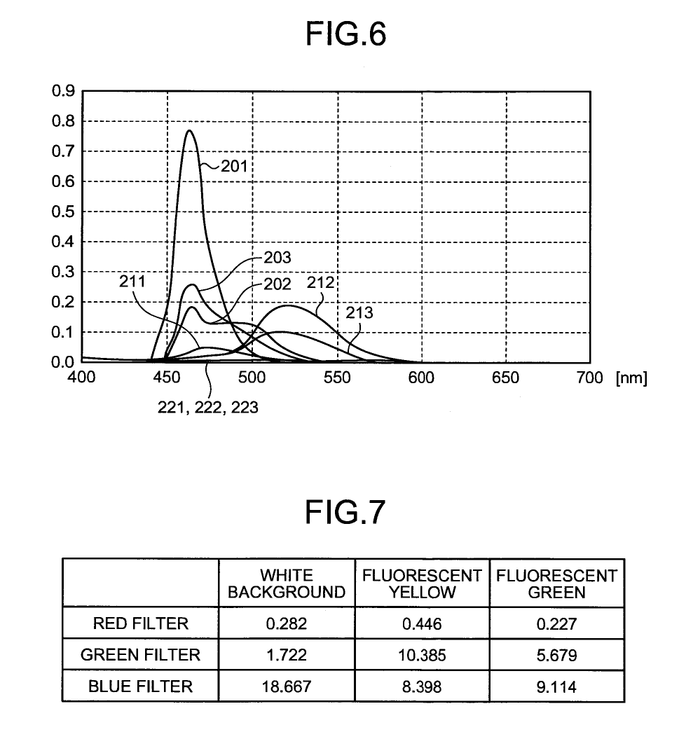

FIG. 6 is a diagram illustrating results obtained by multiplying the spectra with the relative spectral characteristics at the time of irradiation with the blue LED (see FIG. 2) by each color filter characteristic of the image sensor illustrated in FIG. 5. That is, FIG. 6 illustrates each spectrum of light that enters a sensor for each color from each fluorescent pen and the white background when the blue LED is applied.

In FIG. 6, a code 201 represents a product of the spectrum 101 of the white background and the blue filter characteristic B1, a code 202 represents a product of the spectrum 102 of the yellow fluorescent pen and the blue filter characteristic B1, and a code 203 represents a product of the spectrum 103 of the green fluorescent pen and the blue filter characteristic B1, which are obtained at the time of irradiation with the blue LED. Furthermore, a code 211 represents a product of the spectrum 101 of the white background and the green filter characteristic G1, a code 212 represents a product of the spectrum 102 of the yellow fluorescent pen and the green filter characteristic G1, and a code 213 represents a product of the spectrum 103 of the green fluorescent pen and the green filter characteristic G1, which are obtained at the time of irradiation with the blue LED. Moreover, a code 221 represents a product of the spectrum 101 of the white background and the red filter characteristic R1, a code 222 represents a product of the spectrum 102 of the yellow fluorescent pen and the red filter characteristic R1, and a code 223 represents a product of the spectrum 103 of the green fluorescent pen and the red filter characteristic R1, which are obtained at the time of irradiation with the blue LED.

FIG. 7 is a diagram illustrating values obtained by integrating the spectra illustrated in FIG. 6, in particular, outputs from the red sensor 21, the green sensor 22, and the blue sensor 23 with respect to each detection target irradiated with the blue LED 13.

As illustrated in FIG. 7, the red sensor 21 (the red filter) outputs almost nothing with respect to the white background, the yellow fluorescent pen, and the green fluorescent pen. This is because the reflected light (at a wavelength in a range from 450 nm to 480 nm) and fluorescence (at a wavelength in a range from 500 nm to 550 nm) at the time of irradiation with the blue LED 13 can hardly pass through the red filter.

Regarding outputs from the green sensor 22 (the green filter), each output of the yellow fluorescent pen and the green fluorescent pen is larger than an output of the white background. In contrast, an image drawn with non-fluorescent normal ink generates no outputs larger than the output of the white background, so that the output of the white background becomes the largest. Therefore, a region that generates an output larger than the output of the white background can be identified as a fluorescent region. Furthermore, in this identification, if a difference between the output of the white background and the output of the fluorescent region increases, then the fluorescent region can be identified with higher sensitivity. As illustrated in FIG. 7, the output of the yellow fluorescent pen is about six times larger than the output of the white background, and even the output of the green fluorescent pen is about three times larger than the output of white background. Therefore, the fluorescent region drawn with the yellow fluorescent pen and the green fluorescent pen can be identified with high sensitivity.

Regarding outputs from the blue sensor 23 (the blue filter), an output of the white background is larger than each output of the yellow fluorescent pen and the green fluorescent pen. The yellow fluorescent pen and the green fluorescent pen absorb blue light as excitation light and emit green fluorescence, so that a relative output of the blue light decreases. Accordingly, the white background becomes the brightest like reflection characteristics of the non-fluorescent ink. Therefore, when the blue LED is lighting, it is difficult to discriminate the output of the fluorescent region from the output of an image drawn with non-fluorescent ink based on the outputs from the blue sensor 23. Consequently, the most suitable condition for reading the fluorescent region as an image when the blue LED 13 is lighting becomes as follows: irradiation with the blue LED and use of outputs from the green filter. That is, for selectively extracting the fluorescent component, it is preferable to use the outputs from the image sensor having a filter at a wavelength that is different from the wavelength of the excitation light to be applied and that corresponds to a wavelength range of the fluorescence generated by the fluorescent region.

In the image reading apparatus of the present embodiment, the yellow fluorescent region and the green fluorescent region are identified based on the outputs from the green sensor 22 at the time of irradiation with the blue LED 13. In other words, fluorescent image data is generated based on the outputs from the green sensor 22 (predetermined color data) obtained when the blue LED 13 is lighting as a predetermined light source, with respect to the yellow fluorescent region and the green fluorescent region that generate G-color light in the visible region (fluorescence as light in a second wavelength range) different from B-color light (light in a first wavelength range) upon reception of the B-color light. Therefore, it is possible to identify the yellow fluorescent region, the green fluorescent region, and the like contained in a read target image with high sensitivity.

Furthermore, as described above with reference to FIG. 3, each fluorescent component of the pink fluorescent pen and the magenta fluorescent pen at the time of irradiation with the green LED 12 has the peak in the wavelength range from 580 nm to 600 nm, which overlaps a red wavelength range (the red filter characteristic R1). On the other hand, the spectrum 111 of the white background at the time of irradiation with the green LED 12 overlaps the red filter characteristic R1 at a smaller degree than do the pink fluorescent pen and the magenta fluorescent pen. Therefore, regarding the outputs from the red sensor 21 at the time of irradiation with the green LED 12, each value of the pink fluorescent pen and the magenta fluorescent pen becomes larger than a value of the white background. In the present embodiment, the pink fluorescent region and the magenta fluorescent region are identified based on the outputs from the red sensor 21 at the time of irradiation with the green LED 12. In other words, fluorescent image data is generated based on the outputs from the red sensor 21 (predetermined color data) obtained when the green LED 12 is lighting as a predetermined light source, with respect to the pink fluorescent region and the magenta fluorescent region that generate R-color light in the visible region (fluorescence as light in a second wavelength range) different from G-color light (light in a first wavelength range) upon reception of the G-color light. Therefore, it is possible to identify the pink fluorescent region and the magenta fluorescent region contained in a read target image with high sensitivity.

FIG. 8 is a diagram illustrating a state in which fluorescence in red wavelengths, which is generated by irradiating a fluorescent region drawn with a pink fluorescent pen with the green LED 12, enters the red sensor 21 having the red filter.

The light source 10 turns on each LED by being driven by an LED driving unit 41 to be described later. The light source 10 is able to sequentially switch to turn on the LEDs in respective colors. That is, the light source 10 can realize the following states by sequential transition: a state in which the red LED 11 is on and the green LED 12 and the blue LED 13 are off; a state in which the green LED 12 is on and the red LED 11 and the blue LED 13 are off; and a state in which the blue LED 13 is on and the red LED 11 and the green LED 12 are off. FIG. 8 illustrates the state in which the green LED 12 is on and the red LED 11 and the blue LED 13 are off.

Light emitted from the green LED 12 and reflected by a read line as a read target line on the original S is converged by the lens 30 and then enters the red sensor 21. Similarly, fluorescence generated by a fluorescent region on the read line upon reception of the light emitted from the green LED 12 is converged by the lens 30 and then enters the red sensor 21. When the amount of received light by each pixel of the red sensor 21 is larger than the amount of received light corresponding to the white background, a region corresponding to each pixel on the original S can be identified as a fluorescent image (fluorescent region).

Next, a main configuration of the image reading apparatus 1-1 is described with reference to FIG. 9. FIG. 9 is a block diagram of the main configuration of the image reading apparatus 1-1. The image reading apparatus 1-1 includes a control unit 40. The control unit 40 includes the LED driving unit 41, a light-source control unit 42, an image input unit 43, an image processing unit 44, and an image-data output unit 45.

The light-source control unit 42 controls a color, a period, a light quantity, an order of lighting, and the like for each LED to be turned on in the light source 10. The light-source control unit 42 outputs a command value related to a control to turn on the light source 10 to the LED driving unit 41 and the image processing unit 44.

The LED driving unit 41 drives the LED of the light source 10 to turn on the LED. The LED driving unit 41 supplies a current to an LED in a lighting target color to turn on the LED based on the command from the light-source control unit 42. For example, when the green LED 12 is to be turned on, the LED driving unit 41 supplies a current to all the green LEDs 12 arranged in the light source 10 to turn on the green LEDs 12, and stops supply of a current to all the red LEDs 11 and the blue LEDs 13 to turn off the red LEDs 11 and the blue LEDs 13.

The image input unit 43 receives an electrical signal (analog signal) output from the three-line sensor 20, amplifies the electrical signal, converts the electrical signal by performing A/D conversion, and sends the electrical signal to the image processing unit 44. That is, the image input unit 43 functions as an amplifying unit. The image input unit 43 acquires an output from the red sensor 21 as red line data (R-color data) that is red component data related to an image on a read line, an output from the green sensor 22 as green line data (G-color data), and an output from the blue sensor 23 as blue line data (B-color data). Each acquired line data is amplified, converted by the A/D conversion, and sent from the image input unit 43 to the image processing unit 44.

The image processing unit 44 classifies each line data sent from the image input unit 43 into normal image data or fluorescent image data. Here, the normal image data is image data of a whole image including a fluorescent region, or image data of a whole image excluding light of a fluorescent component that is generated by the fluorescent region. In other words, the normal image data is the image data of an image on the original S and contains image data based on at least reflected light other than the fluorescent component. In the present embodiment, image data from which the fluorescent component is excluded is acquired as the normal image data.

The image-data output unit 45 outputs, as image data, line data output from the image processing unit 44. The image-data output unit 45 includes a storage unit for temporarily stores each line data of the normal image data and each line data of the fluorescent image data, generates color image data by combining each line data of the normal image data, and generates fluorescent image data from each line data of the fluorescent image data. In the present embodiment, the image-data output unit 45 functions as a fluorescent-image-data generating unit. There can be a configuration in which the image-data output unit 45 outputs each line data to a data processing device (PC and the like) connected to the image reading apparatus 1-1 so that the data processing device can generate the color image data of the normal image and the fluorescent image data.

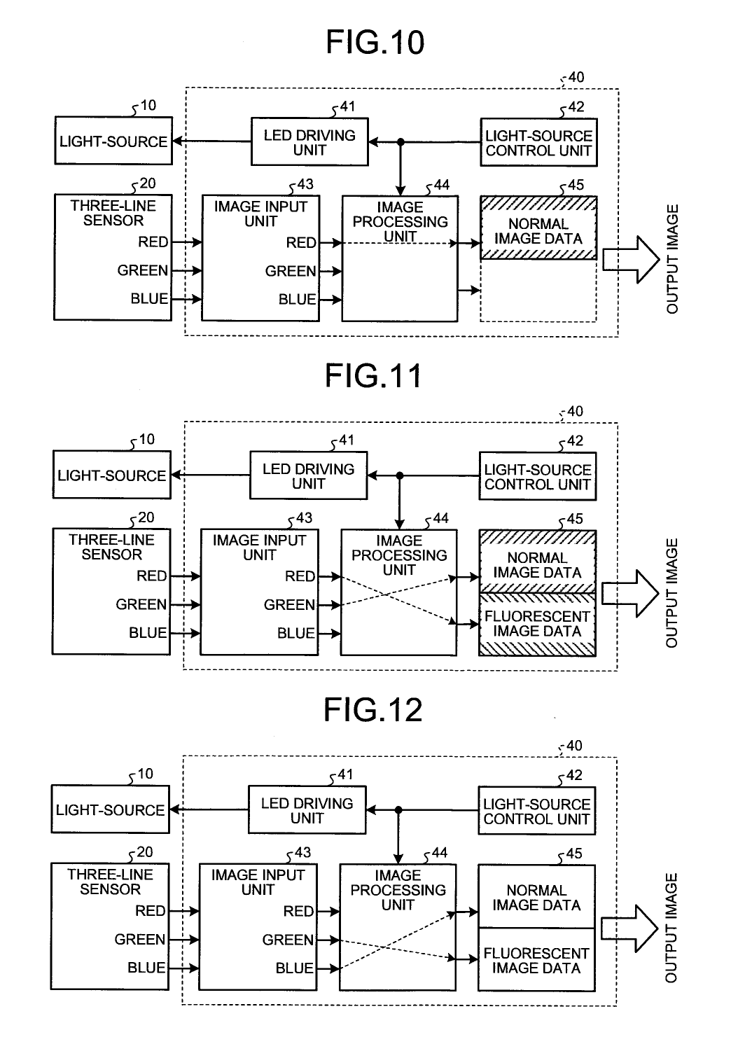

With reference to FIGS. 10 to 12, a method for classifying data into the normal image data or the fluorescent image data according to color of an LED to be turned on will be described. FIG. 10 illustrates an image processing method performed when the red LED 11 is turned on. FIG. 11 illustrates the image processing method performed when the green LED 12 is turned on. FIG. 12 illustrates an image processing method performed when the blue LED 13 is turned on.

When the red LED 11 is to be turned on (FIG. 10), the light-source control unit 42 outputs a command to turn on the red LED 11 to the LED driving unit 41. Accordingly, the LED driving unit 41 supplies a current to the red LED 11 to turn on the red LED 11, so that the original S is irradiated with red light. When the red LED 11 is lighting, as described above with reference to FIG. 4, fluorescent in the visible region is not generated. Therefore, outputs from the red sensor 21 of the three-line sensor do not contain the fluorescent component, resulting in normal image data (a red component of the normal image data). The image processing unit 44 acquires red line data from the image input unit 43, and outputs it as the normal image data to the image-data output unit 45. Blue line data and green line data obtained when the red LED 11 is lighting are not used as the image data.

When the green LED 12 is to be turned on (FIG. 11), the light-source control unit 42 outputs a command to turn on the green LED 12 to the LED driving unit 41. Accordingly, the LED driving unit 41 supplies a current to the green LED 12 to turn on the green LED 12, so that the original S is irradiated with green light. When the green LED 12 is lighting, fluorescence in red regions is generated by the pink fluorescent region, the magenta fluorescent region, and the like. The image processing unit 44 identifies the fluorescent region based on red line data acquired from the image input unit 43. The image processing unit 44 determines an output that exceeds a predetermined threshold to be data of a fluorescent image, from among outputs of pixels of the red line data. The threshold is set based on the magnitude of the output from the red sensor 21, which corresponds to reflected light obtained from the white background when the green LED 12 is lighting. The image processing unit 44 outputs the line data of the fluorescent region obtained as described above to the image-data output unit 45. Furthermore, the image processing unit 44 outputs green line data acquired from the image input unit 43 to the image-data output unit 45 as the normal image data (a green component of the normal image data).

When the blue LED 13 is to be turned on (FIG. 12), the light-source control unit 42 outputs a command to turn on the blue LED 13 to the LED driving unit 41. Accordingly, the LED driving unit 41 supplies a current to the blue LED 13 to turn on the blue LED 13, so that the original S is irradiated with blue light. When the blue LED 13 is lighting, fluorescence in green regions is generated by the yellow fluorescent region and the green fluorescent region. The image processing unit 44 identifies the fluorescent region based on green line data acquired from the image input unit 43. The image processing unit 44 determines an output that exceeds a predetermined threshold to be data of the fluorescent image, from among outputs of pixels of the green line data. The threshold is set based on the magnitude of the output from the green sensor 22, which corresponds to reflected light obtained from the white background when the blue LED 13 is lighting. The image processing unit 44 outputs the line data of the fluorescent region obtained as described above to the image-data output unit 45. Furthermore, the image processing unit 44 outputs blue line data acquired from the image input unit 43 to the image-data output unit 45 as the normal image data.

The image reading apparatus 1-1 sequentially turns on the red LED 11, the green LED 12, and the blue LED 13 with respect to the original S being conveyed in the sub-scanning direction by the conveying device, and generates one piece of line data from pieces of line data obtained by each LED. More specifically, the image-data output unit 45 generates RGB color line data (color image data) as the normal image data based on the red line data obtained when the red LED 11 is lighting, the green line data obtained when the green LED 12 is lighting, and the blue line data obtained when the blue LED 13 is lighting. By repeating acquisition of the RGB color line data in the main-scanning direction in sequence along the sub-scanning direction, a normal image of the original S can be generated as the RGB color image data.

The red line data obtained when the green LED 12 is lighting and the green line data obtained when the blue LED 13 is lighting become fluorescent line data. By repeating acquisition of the fluorescent line data in the main-scanning direction in sequence along the sub-scanning direction, the image-data output unit 45 can generate the fluorescent image data of the image formed on the original S. The fluorescent image data obtained at this time is image data of the whole image of the original S including the fluorescent region. In the fluorescent image data, the fluorescent region appears bright (with large light quantity) and regions other than the fluorescent region appear dark (with small light quantity, for example, 0). In this manner, the fluorescent image data is generated as data of only the separated fluorescent region based on the red or green fluorescent component generated from the fluorescent region on the original S.

It is possible to configure an image reading system that crops a read region surrounded by the fluorescent image data or performs OCR processing on character information in the normal image data overlapping the fluorescent image data, based on the separated fluorescent region. In the present embodiment, the fluorescent component of the fluorescent region can selectively be extracted, so that a region of the fluorescent image can be identified with high sensitivity. Consequently, it is possible to increase the degree of precision of the image reading system that performs image processing based on the fluorescent region.

Furthermore, the fluorescent region can be acquired as image data separated from and independent of the normal image, so that various types of image processing in which the fluorescent component and the normal image are combined with each other can be performed. For example, it is possible to generate an image in which a region that is marked with a fluorescent pen is emphasized, or it is possible to generate an image in which reproducibility of fluorescent colors is improved (an image whose color tone is optimized to be visible by human eyes).

According to the image reading apparatus 1-1 of the present embodiment, fluorescent identification can be performed without a need of a special light source such as an ultraviolet ray for exciting fluorescence. Because a fluorescent image drawn with fluorescent ink can be separated by using the light sources that emit visible light in combination, costs can be more reduced than a configuration with a special light source.

Described below is a difference between sensitivity in a fluorescence identification method according to the present embodiment and sensitivity in a conventional identification method. The feature of a fluorescent color lies in that it absorbs excitation light and emits fluorescence at a wavelength longer than that of the excitation light. In the conventional fluorescence identification method, fluorescence is identified based on an output from the image sensor, which contains not only an output of the fluorescence but also an output of reflected light. Therefore, as described below, it is difficult to increase the sensitivity for identifying the fluorescent region.

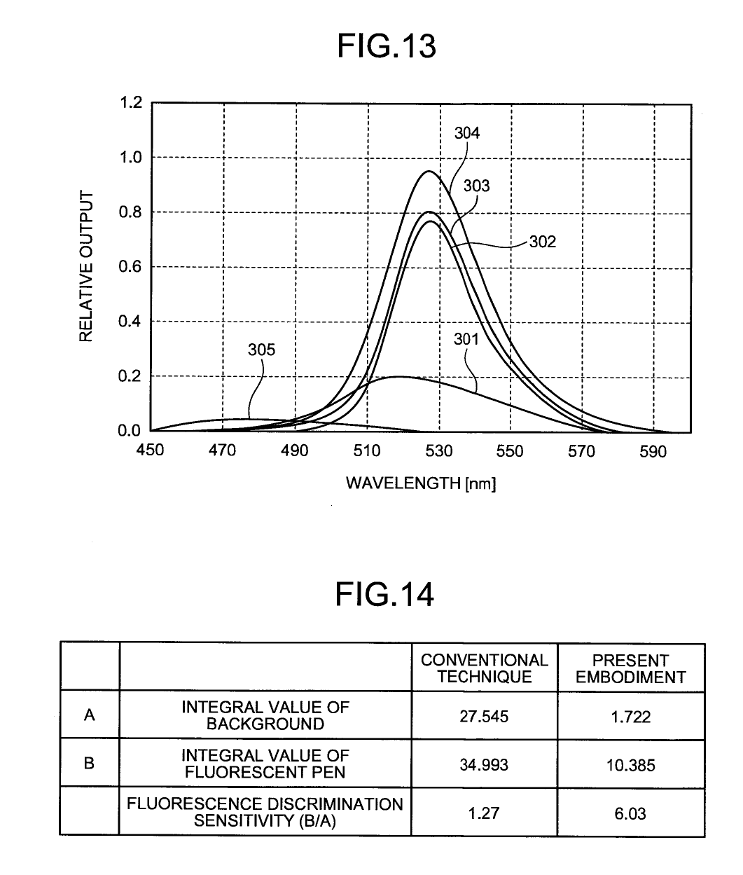

FIG. 13 is a diagram illustrating results obtained by multiplying each spectrum of the yellow fluorescent pen and the white background by a green filter characteristic at each wavelength. FIG. 13 illustrates a product between the spectrum and the filter characteristic under each lighting condition when the lighting conditions of the light source 10 (color of an LED to be turned on) are changed. A code 301 represents a value of the yellow fluorescent pen at the time of irradiation with the blue LED 13, a code 302 represents a value of the yellow fluorescent pen at the time of irradiation with the green LED 12, a code 303 represents a value of the white background when both the green LED 12 and the blue LED 13 are lighting, a code 304 represents a value of the yellow fluorescent pen when both the green LED 12 and the blue LED 13 are lighting, and a code 305 represents a value of the white background when the blue LED 13 is lighting.

The code 301 represents a spectrum of green fluorescence generated by the fluorescent pen upon absorption of blue light as excitation light, which represents a fluorescent component. The code 302 represents a spectrum of green light reflected by the fluorescent pen upon irradiation with the green LED 12, which represents a reflection component. Conventionally, the fluorescence identification has been performed based on an output from the image sensor upon irradiation with light, such as white light, containing both blue light and green light. That is, the fluorescence identification has been performed based on a value of integral of the spectrum containing both the reflection component (302) and the fluorescent component (301) as indicated by the code 304. Because a difference between the spectrum 304 and the spectrum 303 of the white background obtained when the green LED 12 and the blue LED 13 are lighting is small, as illustrated in FIG. 14, a difference between outputs from the image sensor is not so large. FIG. 14 is a diagram illustrating outputs from the green sensor 22 with respect to incident light from each of the yellow fluorescent pen and the white background, in which the value of each spectrum illustrated in FIG. 13 is integrated by 1 nm.

In FIG. 14, “value of integral of background” of the conventional technique corresponds to a value of integral of the spectrum 303 illustrated in FIG. 13, and “value of integral of fluorescent pen” of the conventional technique corresponds to a value of integral of the spectrum 304 illustrated in FIG. 13. A difference between the “value of integral of background” and the “value of integral of fluorescent pen” is not so large.

In contrast, in the present embodiment, a large difference between the spectrum 301 of the yellow fluorescent pen and the spectrum 305 of the white background at the time of irradiation with the blue LED 13 is used. In FIG. 14, “value of integral of fluorescent pen” of the present embodiment corresponds to a value of integral of the spectrum 301 of the yellow fluorescent pen at the time of irradiation with the blue LED 13 as illustrated in FIG. 13, and “value of integral of background” of the present embodiment corresponds to an integral value of the spectrum 305 of the white background at the time of irradiation with the blue LED 13 as illustrated in FIG. 13. The reason why a few outputs are obtained in the “value of integral of background” is that there is an overlapping region between the blue filter characteristic B1 and the green filter characteristic G1 in the filter characteristic of the three-line sensor 20 (see FIG. 5).

When compared regarding fluorescence identification sensitivity that is a ratio of the “value of integral of fluorescent pen” to the “value of integral of background”, the identification method of the present embodiment achieves about five times higher sensitivity than the conventional identification method. Thus, in the identification method of the present embodiment, because fluorescence emitted from the fluorescent region is extracted and received by the image sensor, it is less likely to be affected by the reflected light and the fluorescent region can be identified with high sensitivity. The “value of integral of background” of the present embodiment is an output to be output even when the fluorescent region does not exist, so that if the value is used as a reference for black, the sensitivity of the fluorescence identification can be further improved.

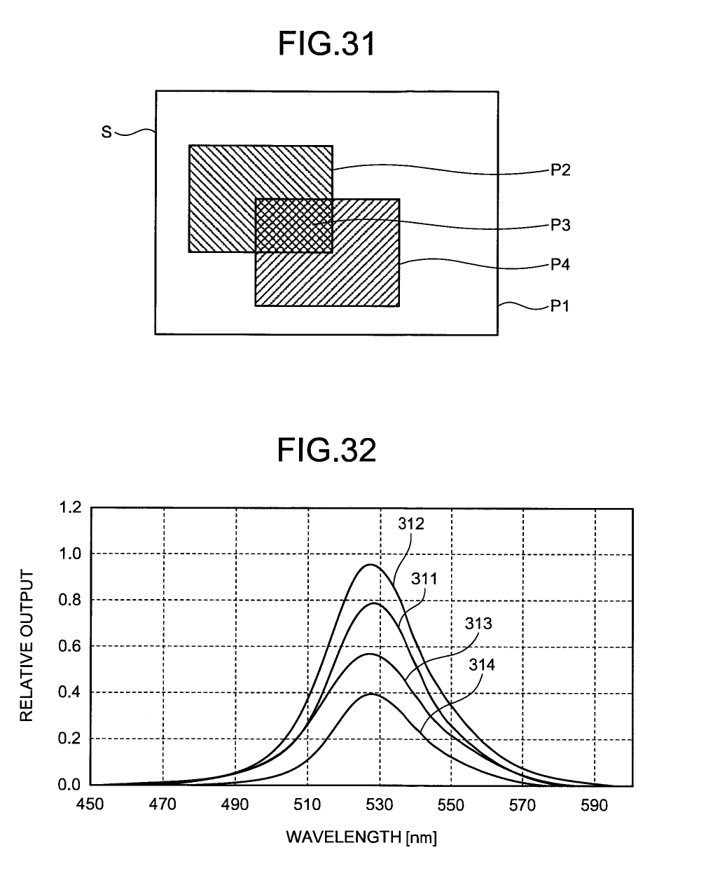

Furthermore, in the method for identifying the fluorescent region according to the present embodiment, the fluorescent region can be identified without being affected by density of a background of the fluorescent region. In the conventional technique, the fluorescent region is identified by comparing the amount of received light of the reflected light from a background (the brightest portion in the background) with the amount of received light with respect to the fluorescent region containing the reflection component and the fluorescent component. Therefore, as described below with reference to FIGS. 31 to 33, the density of the background of the fluorescent region affects the sensitivity for the identification, which may result in inaccurate identification of the fluorescent region.

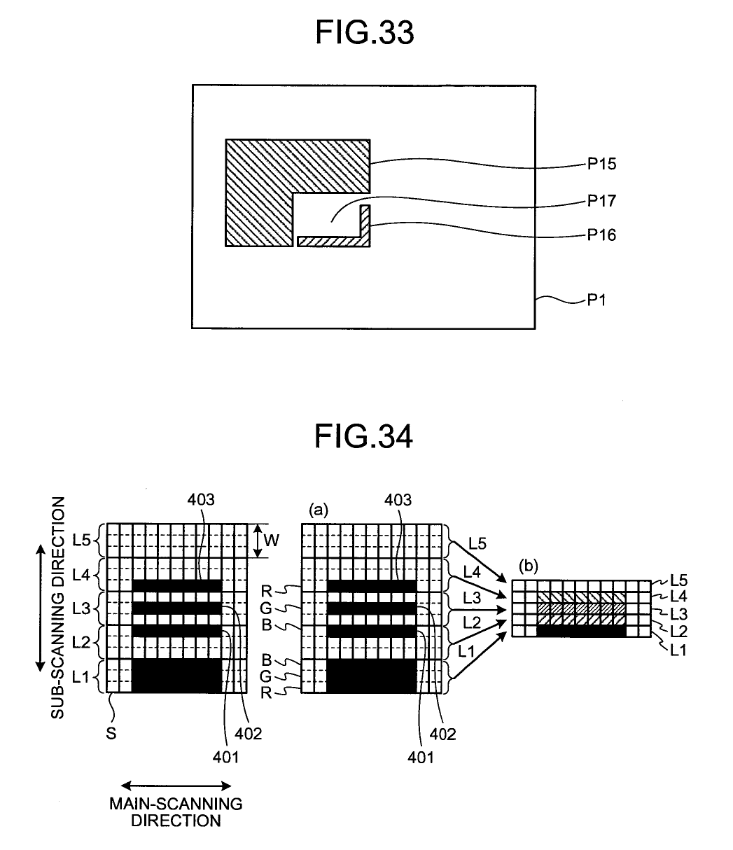

FIG. 31 illustrates an example of an image containing a fluorescent region that cannot be identified accurately by the conventional technique. FIG. 32 is a diagram illustrating a spectral characteristic of each region of the image containing the fluorescent region that cannot be identified accurately by the conventional technique. FIG. 33 illustrates an example of a result of identification of the fluorescent region by the conventional technique.

In FIG. 31, a code P1 represents a region of the white background of the original S, a code P2 represents a region of a fluorescent image drawn with a yellow fluorescent pen, a code P4 represents a gray background region having a reflectivity of 50% with respect to the white background, and a code P3 represents a region in which the fluorescent yellow and the gray background overlap each other (hereinafter, simply referred to as “an overlapped region P3”).

FIG. 32 illustrates spectra of the regions P1 to P4 when the blue LED 13 and the green LED 12 are lighting, which are values multiplied by the filter characteristic G1 of the green sensor 22. That is, a value obtained by integrating each spectrum illustrated in FIG. 32 corresponds to an output of the green sensor 22 when the blue LED 13 and the green LED 12 are lighting. A code 311 represents a spectrum obtained from the white background region P1, a code 312 represents a spectrum obtained from the fluorescent yellow region P2, a code 313 represents a spectrum obtained from the overlapped region P3, and a code 314 represents a spectrum obtained from the gray background region P4.

As can be seen from FIG. 32, regarding the outputs from the green sensor 22, a value corresponding to the fluorescent yellow region P2 is the largest, and values corresponding to the white background region P1, the overlapped region P3, and the gray background region P4 decrease in this order. That is, although the fluorescent yellow region can be identified as the fluorescent region by comparison with the white background region P1, the overlapped region P3 cannot be identified as the fluorescent region because the magnitude of its output is similar to those of other images that do not emit fluorescence. It may be possible to perform the fluorescence discrimination on the overlapped region P3 based on the gray background region; however, in this case, error detection may occur when a range of the gray background region is not recognized accurately. That is, although the fluorescent identification can be successfully performed at a boundary portion between the overlapped region P3 and the gray background region P4, it is likely that a fluorescent region at portions distant from the gray background region P4 is erroneously detected. Therefore, these portions are preferably excluded from an identification object.

Consequently, in the overlapped region P3, a blank appears in a region identified as a fluorescent image. In FIG. 33, a code P15 represents a region identified as the fluorescent region by comparison with the white background region P1, and a code P16 represents a region identified as the fluorescent region by comparison with the gray background region P4. A left-out region P17 that is actually the fluorescent region but is not identified as the fluorescent region appears between the two regions P15 and P16 that are identified as the fluorescent regions.

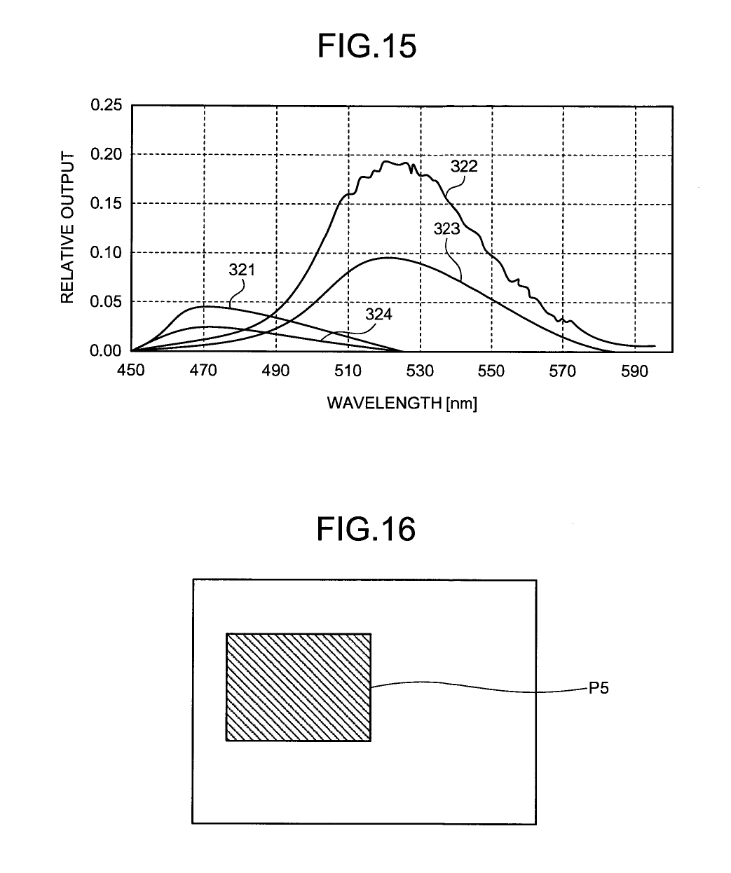

In contrast, in the fluorescence identification method of the present embodiment, the fluorescence identification is performed by extracting the fluorescent components and comparing the extracted results with each other. Because the filter of the green sensor 22 can hardly transmit reflected light (blue light) at the time of irradiation with the blue LED 13, the outputs from the green sensor 22 can be assumed as the fluorescent components, so that the fluorescence identification can be performed without being (practically) affected by the reflected light. That is, because the effect of the reflected light is extremely small, it is possible to maintain high sensitivity for the fluorescence identification regardless of the density of a background overlapping the fluorescent region. FIG. 15 is a diagram illustrating spectral characteristics of each region, which are obtained by the fluorescence identification according to the present embodiment. FIG. 16 illustrates an example of a result of identification of the fluorescent region by the fluorescence identification according to the present embodiment.

FIG. 15 illustrates spectra of the regions P1 to P4 when the blue LED 13 is lighting (the green LED 12 is not lighting), which are values multiplied by the filter characteristic G1 of the green sensor 22. That is, a value obtained by integrating each spectrum illustrated in FIG. 15 corresponds to an output from the green sensor 22 when the blue LED 13 is lighting. A code 321 represents a spectrum corresponding to the white background region P1, a code 322 represents a spectrum corresponding to the fluorescent yellow region P2, a code 323 represents a spectrum corresponding to the overlapped region P3, and a code 324 represents a spectrum corresponding to the gray background region P4.

As can be seen from FIG. 15, a relative output of the spectrum 321 of the white background region P1 is small, and a relative output of the spectrum 324 of the gray background region P4 is even smaller. In other words, outputs with respect to the white background and the gray background that correspond to reflection components are remained at small level. On the other hand, a relative output of the spectrum 322 of the fluorescent yellow region P2 and a relative output of the spectrum 323 of the overlapped region P3 are larger than the spectrum 321 of the white background region P1. That is, even when the fluorescent region overlaps the background having high density, the relative output of the fluorescent region exceeds the relative output of the spectrum 321 of the white background region P1. Therefore, according to the fluorescence identification method of the present embodiment, the fluorescence identification can be performed with high sensitivity without being affected by the density of the background. In FIG. 16, a code P5 represents a region identified as the fluorescent region by using the fluorescence identification method of the present embodiment. As described above, in the fluorescence identification of the present embodiment, the fluorescent region can be detected accurately without generating a blank region or causing error detection.

The readable fluorescent region is not limited to an image drawn with a fluorescent pen. For example, a fluorescent region drawn with fluorescent ink or the like by offset printing is also readable. In other words, the image reading apparatus 1-1 of the present embodiment can identify any fluorescent regions containing fluorescent material that emits fluorescence in a wavelength range different from that of excitation light upon reception of the excitation light in the visible region. Consequently, if there is fluorescent material that emits light in the visible region different from red light upon reception of the red light, a fluorescent region containing this fluorescent material can also be identified.

### Second Embodiment

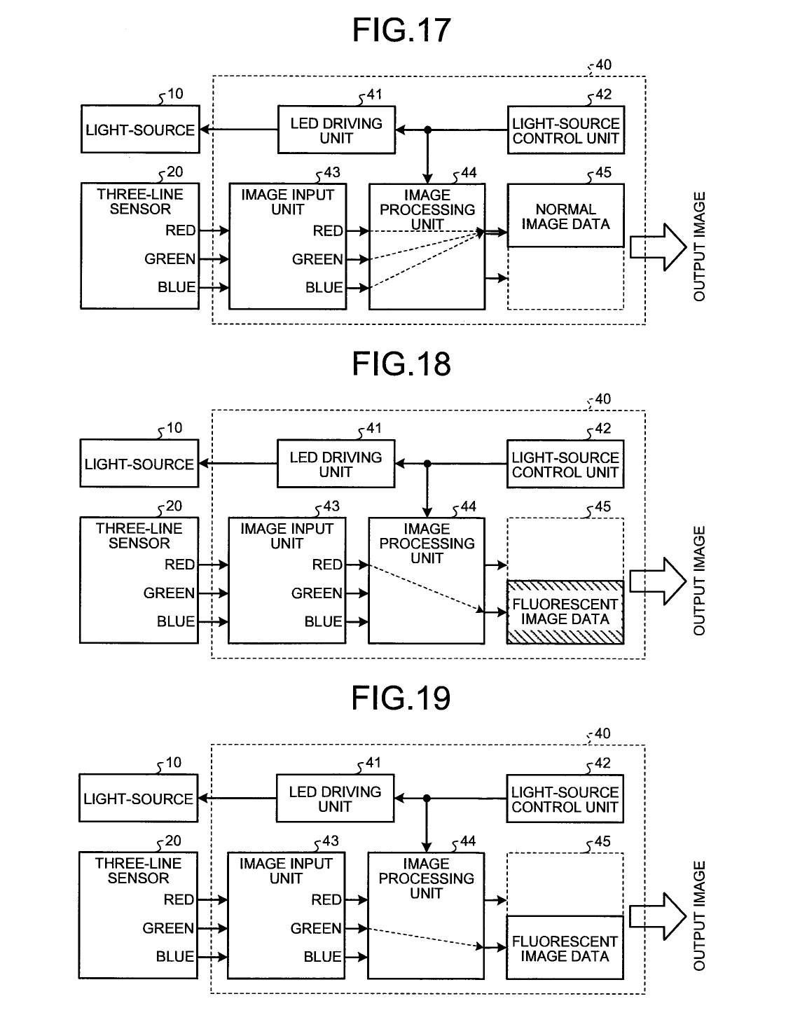

A second embodiment of the present invention will be described with reference to FIGS. 17 to 19. In the second embodiment, only a difference from the above-mentioned embodiment will be described. A difference in image reading between the above-mentioned first embodiment and the second embodiment lies in a method of capturing a normal image. In the above-mentioned first embodiment, an image from which a fluorescent component is excluded is obtained as the color image data of the normal image; however, in the present embodiment, an image containing the fluorescent component is obtained as the color image data of the normal image. Because the color image data of the normal image can be output as it is without performing any processing as an image containing the fluorescent component like a color image obtained by using a conventional white light source, circuits in subsequent stages, such as the image processing unit 44, can be simplified.

Generally, a fluorescence wavelength becomes longer than a wavelength of the light source. The image reading apparatus 1-1 does not include a sensor that receives light with a wavelength longer than that of red light, so that even when fluorescence with a wavelength longer than that of the red light is generated by lighting the red LED 11, this fluorescence cannot be detected. Therefore, the red LED 11 can be excluded from the light sources that apply visible light for generating fluorescence. Consequently, such a configuration can be applied that fluorescent image data is obtained by independently turning on the green LED 12 and the blue LED 13, and normal image data is read by turning on all the RGB LEDs instead of lighting of the red LED 11. As a result, it is possible to assure compatibility between the color image obtained by using a conventional white light source, which is generated as an image containing the fluorescent component, and color image data of a normal image obtained in the present embodiment. Furthermore, by simply adding a fluorescent-image-data reading unit to a circuit of the conventional image reading apparatus, a function of reading fluorescent image data can be realized.

In the present embodiment, when capturing an image of normal image data, the image reading apparatus 1-1 simultaneously turns on the LEDs in all colors in the light source 10 to irradiate the original S with white light. Color image data of the normal image is generated based on line data output from each of the sensors 21, 22, and 23 of the three-line sensor 20 when the light source 10 is caused to emit white light. At this time, when a fluorescent region that emits green fluorescence like the yellow fluorescent pen and the green fluorescent pen is present on a read line, a fluorescent component as well as the reflection component enter the green sensor 22, and, when a fluorescent region that emits red fluorescence like the pink fluorescent pen and the magenta fluorescent pen is present, a fluorescent component as well as the reflection component enter the red sensor 21. Consequently, the generated normal image contains the fluorescent component. The fluorescence identification method and the method for acquiring the fluorescent image data can be the same as those described in the above-mentioned first embodiment.

FIG. 17 is a diagram illustrating a method for capturing a normal image. FIG. 18 is a diagram illustrating a method for capturing an image of a fluorescent region by lighting the green LED 12. FIG. 19 is a diagram illustrating a method for capturing an image of a fluorescent region by lighting the blue LED 13.

When a normal image is to be captured, as illustrated in FIG. 17, the light-source control unit 42 outputs a command to turn on the red LED 11, the green LED 12, and the blue LED 13 to the LED driving unit 41. Accordingly, the LED driving unit 41 supplies a current to each of the LEDs 11, 12, and 13 to turn on them, so that the original S is irradiated with white light. The image processing unit 44 acquires red line data, green line data, and blue line data from the image input unit 43 and outputs the three pieces of the line data to the image processing unit 44. The image processing unit 44 outputs, as line data of a normal image, the line data received from the image input unit 43 to the image-data output unit 45. The image-data output unit 45 combines the line data for three colors to generate color image line data of the normal image, and outputs the generated color image data.

When fluorescent image data is to be acquired by lighting the green LED 12, as illustrated in FIG. 18, the light-source control unit 42 controls the LED driving unit 41 to turn on the green LED 12, so that the original S is irradiated with green light. The image processing unit 44 acquires red line data from the image input unit 43, and determines an output that exceeds a predetermined threshold to be data of a fluorescent region, from among outputs of the pixels of the red sensor 21. The image processing unit 44 outputs the obtained line data of the fluorescent region to the image-data output unit 45.

When fluorescent image data is to be acquired by lighting the blue LED 13, as illustrated in FIG. 19, the light-source control unit 42 controls the LED driving unit 41 to turn on the blue LED 13, so that the original S is irradiated with blue light. The image processing unit 44 acquires green line data from the image input unit 43, and determines an output that exceeds a predetermined threshold to be data of the fluorescent region, from among outputs of the pixels of the green sensor 22. The image processing unit 44 outputs the obtained line data of the fluorescent region to the image-data output unit 45.

The image reading apparatus 1-1 sequentially captures, as a main scanning of the read line, a normal image by irradiation with white light, an image of the fluorescent region by irradiation with green light, and an image of the fluorescent region by irradiation with blue light, and repeats the main scanning in the sub-scanning direction along with conveyance of the original S to capture the color image data of the normal image of the original S and the fluorescent image data.

### First Modified Example of the Second Embodiment

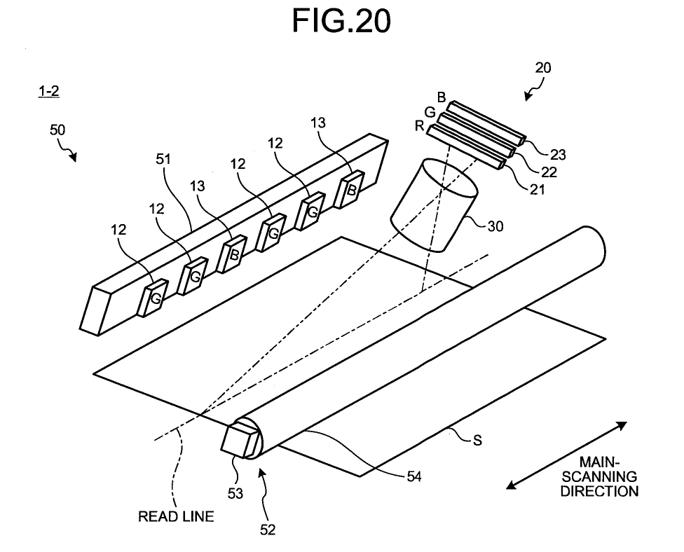

A first modified example of the second embodiment will be described with reference to FIG. 20. FIG. 20 is a diagram of a general configuration of an image reading apparatus 1-2 according to the present modified example.

The image reading apparatus 1-2 of the present modified example is different from the image reading apparatus 1-1 of the above-mentioned embodiments in that a light source 50 includes, as independent light sources, an excitation-light LED array 51 as a light source for excitation light and a white light source 52 for white light. The excitation-light LED array 51 is a light source that irradiates the original S with excitation light to generate fluorescence, and includes the green LED 12 and the blue LED 13. In the excitation-light LED array 51, the number of the green LEDs 12 mounted thereon is larger than the number of the blue LEDs 13 mounted thereon. More specifically, two green LEDs 12 are mounted per blue LED 13. This is because luminous efficiency of the green LED 12 is generally smaller among RGB monochromatic LEDs. In the excitation-light LED array 51, two green LEDs 12 and one blue LED 13 are alternately arranged in an array.

The white light source 52 includes a white LED 53 and a waveguide tube 54. The white LED 53 emits white light by being supplied with a current. The waveguide tube 54 is in a form of a tube and arranged such that one end portion of the tube comes near or in contact with the white LED 53. The waveguide tube 54 is arranged along the main-scanning direction and located at a position opposite the original S. When the white LED 53 is turned on, light emitted from the white LED 53 enters the waveguide tube 54. The light that has entered the waveguide tube 54 travels in the main-scanning direction while being reflected within the waveguide tube 54. A part of the light traveling through the waveguide tube 54 is transmitted to the outside of the waveguide tube 54. Therefore, the white light that has entered the waveguide tube 54 from the white LED 53 is emitted from the whole waveguide tube 54 to the outside of the waveguide tube 54. A range of the waveguide tube 54 mounted in the main-scanning direction covers a range through which the original S passes. Therefore, the white light emitted from the waveguide tube 54 can irradiate the whole read line of the original S.

A method for capturing images of the normal image data and the fluorescent image data by the image reading apparatus 1-2 can be the same as the method for capturing images by the image reading apparatus 1-1 as described in the second embodiment. In this case, there is a difference in that the white LED 53 is turned on instead of lighting of all the red LED 11, the green LED 12, and the blue LED 13 when the white light is applied to capture the normal image.

The image reading apparatus 1-2 can be configured such that each of the green LED 12 and the blue LED 13 for reading the fluorescent region is formed as an LED with a forward current of a several tens mA and the white light source 52 is formed by combining a white LED, which is formed of yellow phosphor and a blue LED to achieve high luminous efficiency and has a forward current of a several hundreds mA, and the waveguide tube 54. Because the green LED 12 that has low luminous efficiency is not used for the normal image, the entire luminous efficiency can be improved, which is preferable for practical purpose.

### Second Modified Example of the Second Embodiment

A second modified example of the second embodiment will be described.

In the second embodiment and the first modified example as described above, because the normal image data is read by lighting the white light source, occurrence of false color can be prevented as described below.

The false color occurs under a condition where the image sensor is a monochromatic line sensor, a light source is an RGB three-color light source, and the like. FIG. 34 is a diagram for explaining occurrence of the false color in conventional image reading. In FIG. 34, a relationship between timing for lighting a light source for each RGB color and a position of a line image is illustrated at (a), and image data generated by combining outputs of respective colors is illustrated at (b).

The original S contains three line images, each of which is thinner than a pixel width W. Each line image has a width of one-third of the pixel width W, and is extended in the main-scanning direction. A line image 401 present on a line L2, a line image 402 present on a line L3, and a line image 403 present on a line L4 are located at line positions different from each other such that the line image 401 is located at one end of the line L2 in the sub-scanning direction, the line image 402 is located in the center of the line L3 in the sub-scanning direction, and the line image 403 is located at other end of the line L4 in the sub-scanning direction.

When an image is to be read by using the RGB three-color light source and the monochromatic line sensor, a red light source, a green light source, and a blue light source are sequentially turned on to acquire line data of each color per scanning of one line. Therefore, when a line image thinner than the pixel width W is present, false color occurs in accordance with timing of lighting the light source for each color and a position of the line image. For example, regarding the line image 401 on the line L2, blue light is applied at the timing when reflected light from the line image 401 enters the monochromatic line sensor, so that an output for blue becomes smaller than outputs for red and green. As a result, color of the line L2 becomes yellow in the generated image, which is the false color. The same occurs in the line L3 and the line L4, in which outputs for green and red become smaller than outputs for other colors and thus the false color occurs. The false color caused by a thin line is likely to occur in a system that switches RGB light sources line-sequentially as employed in a typical contact image sensor, and it also occurs in the color image data of the normal image generated in the first embodiment.

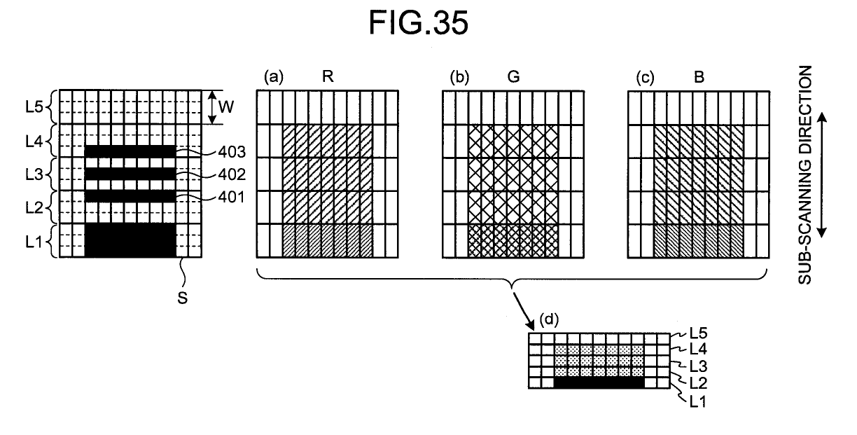

In contrast, in a system that reads an image by using the white light source and the three-line sensor, the false color does not occur. FIG. 35 is a diagram for explaining an image generated by a conventional image reading apparatus that reads an image by using the white light source and the three-line sensor. In FIG. 35, an output from a red sensor is illustrated at (a), an output from a green sensor is illustrated at (b), an output from a blue sensor is illustrated at (c), and image data generated by combining the outputs from the sensors is illustrated at (d).

In the image reading with use of the white light source and the three-line sensor, when a black line thinner than the pixel width W is present, the thin line is not resolved, but is rather integrated with an area and expressed in gray. As illustrated at (d) in FIG. 35, the lines L2, L3, and L4 are expressed as gray images at constant density instead of being expressed as thin lines. As the black line becomes thinner, the density of the gray image is made smaller, which is an ideal condition for an image.

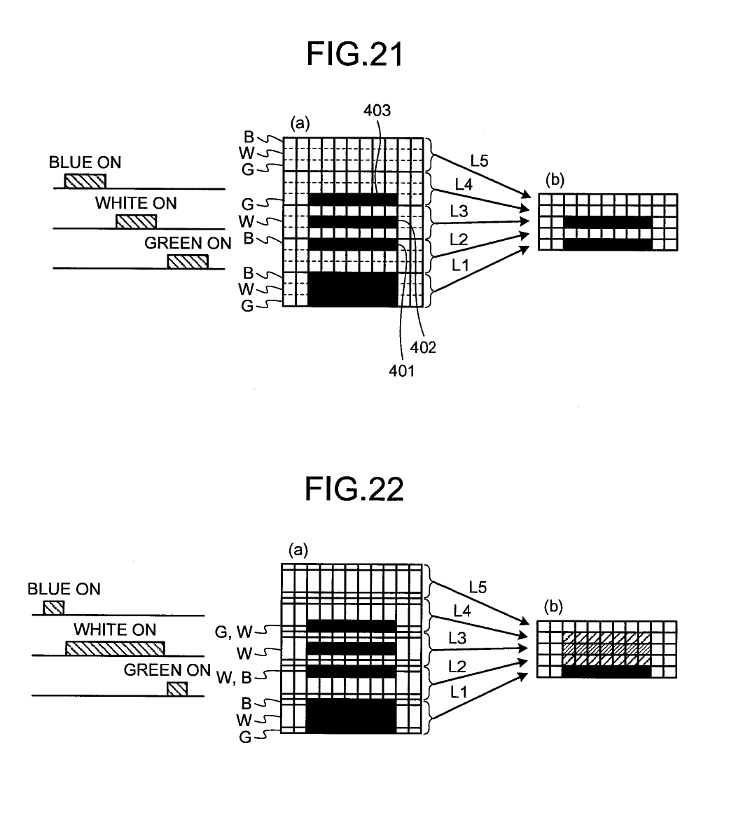

In the second embodiment and the first modified example of the second embodiment, the normal image data is read by using the white light source, and the fluorescent image data is read by using the green light source and the blue light source. Because the normal image data is read by using the white light source and the three-line sensor 20, the false color does not occur. However, as will be described with reference to FIG. 21, jitter sometimes occurs when information is thinned out or emphasized. FIG. 21 is a diagram for explaining occurrence of the jitter.

In FIG. 21, a relationship between a period for lighting each of a green light source G, a white light source W, and a blue light source B and a position of a line image is illustrated at (a), and normal image data generated by combining outputs from each sensor of the three-line sensor 20 is illustrated at (b).

In the line L2, a period for capturing the line image 401 overlaps a period for irradiation with blue light, but does not overlap a period for irradiation with white light (i.e., a period for reading a normal image). Therefore, information is thinned out on assumption that a normal image is not present in the line L2. Similarly, in the line L4, a period for capturing the line image 403 overlaps a period for irradiation with green light, but does not overlap a period for irradiation with white light. Therefore, information is thinned out on assumption that a normal image is not present in the line L4. On the other hand, in the line L3, a period for capturing the line image 402 overlaps a period for irradiation with white light (nearly identical to each other). Consequently, the line image 402 is emphasized on assumption that a line image is present over the whole pixel width. As described above, the jitter occurs in a generated image when information is thinned out or emphasized in the normal image data. In other words, a portion exposed by green and blue is cut out from the normal image, so that the thin line is not expressed accurately, resulting in the jitter.

In the image reading method of the second embodiment and the first modified example as described above, which is the method in which the normal image is extracted by using the white light source, a ratio of an exposure time among the light sources (W, G, and B) can arbitrarily be set unlike in the method in which the normal image data is generated by combining pieces of image data that are sequentially read with light sources for different colors.

In the present modified example, an exposure time of the three-line sensor 20 when the white light source is lighting for generating the color image data of the normal image is set longer than an exposure time of the three-line sensor 20 when the blue LED 13 or the green LED 12 is lighting for generating the fluorescent image data. Therefore, an S/N ratio of the normal image can be increased, occurrence of the jitter can be prevented, and image read speed can be increased.

Explanation about increase in the S/N ratio of the normal image will be given below. Generally, when marking is to be made with a fluorescent pen, a text string is highlighted with a thick line or an area of text is surrounded with thick closing lines. An image generated by such marking becomes information having a low spatial frequency. Therefore, even when a noisy image having a low S/N ratio is obtained by capturing an image of the fluorescent region by the image sensor, the image can be made usable by performing image processing such as denoising, smoothing, or edge enhancement. In contrast, the normal image is required to have a high S/N ratio because it contains small characters, thin lines, or fine shading in a color image. In view of the above, by lengthening the exposure time of the white light source (by increasing a ratio of the exposure time of the white light source) and performing image processing on the fluorescent image data, it is possible to increase the S/N ratio of the normal image and obtain the fluorescent image data in proper quality for intended purposes.

Furthermore, by lengthening the exposure time of the white light source, low jitter can be achieved (continuity of the image of the normal image data can be improved). FIG. 22 is a diagram for explaining suppression of the jitter by lengthening the exposure time of the white light source. In FIG. 22, a relationship between a period for lighting each of the green light source G, the white light source W, and the blue light source B and a position of a line image is illustrated at (a), and normal image data generated by combining outputs from each sensor for each color of the three-line sensor 20 is illustrated at (b).

In the example illustrated in FIG. 22, compared to the exposure time that is equally set for each of green, white, and blue (FIG. 21), the exposure time of the white light source is doubled, and the exposure time of each of the green LED 12 and the blue LED 13 is reduced to half. Therefore, compared to a case where the exposure time is set equally for each of green, white, and blue, a region to be cut out as the fluorescent image portion is reduced to half, and possibility that a thin line and a portion surrounding the thin line are exposed by the white light source is increased because the exposure time of the white light source is doubled. As a result, it is possible to prevent a line image from being thinned out or emphasized, so that an image close to an ideal image in which a thin line portion is expressed as a gray image can be generated.

### Third Embodiment

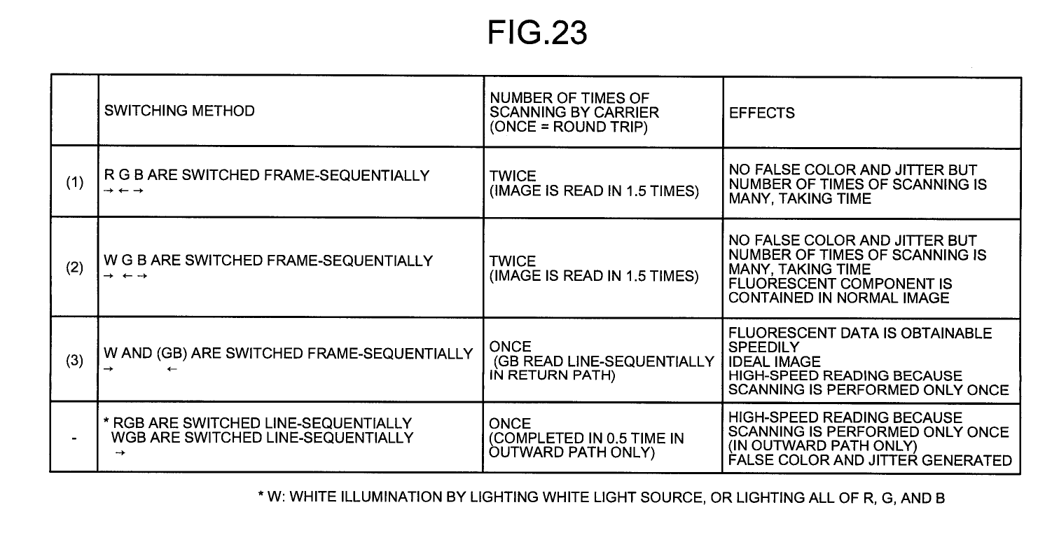

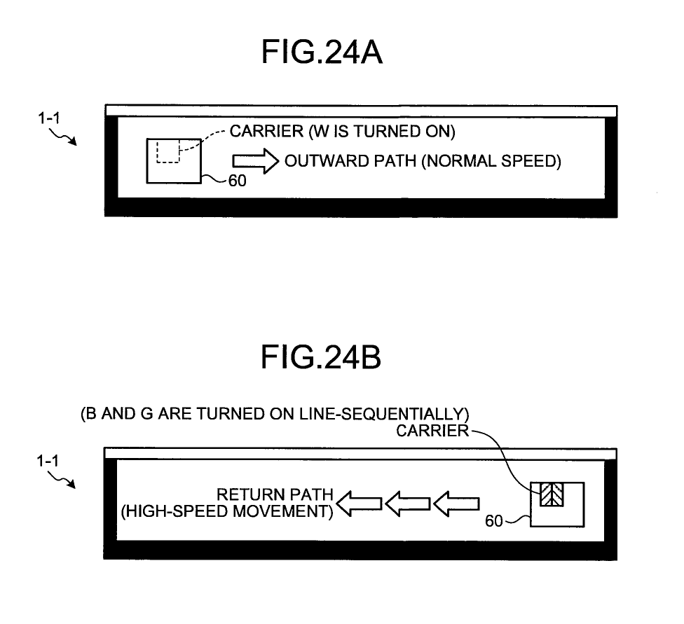

A third embodiment of the present invention will be described with reference to FIGS. 23, 24A and 24B. In the third embodiment, only a difference from the above-mentioned embodiments will be described.

The first embodiment and the second embodiment as described above employ the system that switches the light sources line-sequentially, which is a reading method suitable for a sheet-feed-type image reading apparatus that is required to read an image by one pass. Here, switching of the light sources is not limited to linear sequence, and the light sources can be switched frame-sequentially instead of line-sequentially. Even when the light sources are switched frame-sequentially, the fluorescence identification can be performed with high sensitivity. Furthermore, when the light sources are switched frame-sequentially, false color and jitter do not occur in principle when color image data of the normal image is generated. A method for switching the light sources frame-sequentially is especially effective in a flat-head-type image reading apparatus that moves the image reading unit 1 in the sub-scanning direction by using a carrier.

FIG. 23 is a diagram illustrating effects obtained when light sources of the above-mentioned embodiments are switched frame-sequentially instead of line-sequentially.

In a case (1) where “the red LED 11, the green LED 12, and the blue LED 13 of the first embodiment are sequentially turned on frame-sequentially”, the red LED 11 is turned on in an outward path of the carrier, the green LED 12 is turned on in a return path of the carrier, and the blue LED 13 is turned on in the second outward path of the carrier. Thus, the carrier performs scanning twice. Although the false color and the jitter do not occur by switching the light sources frame-sequentially, because the number of times of the scanning is large, it takes time for reading an image.

Next, in a case (2) where “the white light source, the green LED 12, and the blue LED 13 of the second embodiment are sequentially turned on frame-sequentially”, the carrier performs scanning twice similarly to the case (1). Therefore, although the false color and the jitter do not occur, it takes time for reading an image because the number of times of the scanning is large.

To reduce a reading time compared to the case (2), it is possible to employ a case (3) where “normal image is read in an outward path and all fluorescent regions are read in a return path at one time”. In the return path, the green LED 12 and the blue LED 13 are sequentially turned on line-sequentially to read fluorescent regions that emit fluorescence at different wavelengths. In this configuration, it is possible to acquire fluorescent data at high speed while eliminating a chance of occurrence of the false color and the jitter in the normal image. The normal image and the fluorescent region can be read by one scanning (one round) by the carrier, so that high-speed reading can be achieved.

Furthermore, in the image reading by switching the light sources as described in the case (3), as illustrated in FIGS. 24A and 24B, it is possible to further increase speed of reading the fluorescent region. FIGS. 24A and 24B are schematic diagrams for explaining high-speed image reading for reading the fluorescent region. FIG. 24A illustrates reading of the normal image in the outward path. FIG. 24B illustrates reading of the fluorescent region in the return path. A code 60 denotes the carrier. When fluorescent image data is read by switching the green LED 12 and the blue LED 13 line-sequentially in the return path, the resolution and the S/N ratio of the fluorescent image data can be made smaller than the resolution and the S/N ratio of the normal image data, respectively. Therefore, by driving the three-line sensor 20 at high speed or reading the data with low resolution, the carrier 60 can be moved at higher speed than the speed for reading the normal image (in the outward path).

### Fourth Embodiment

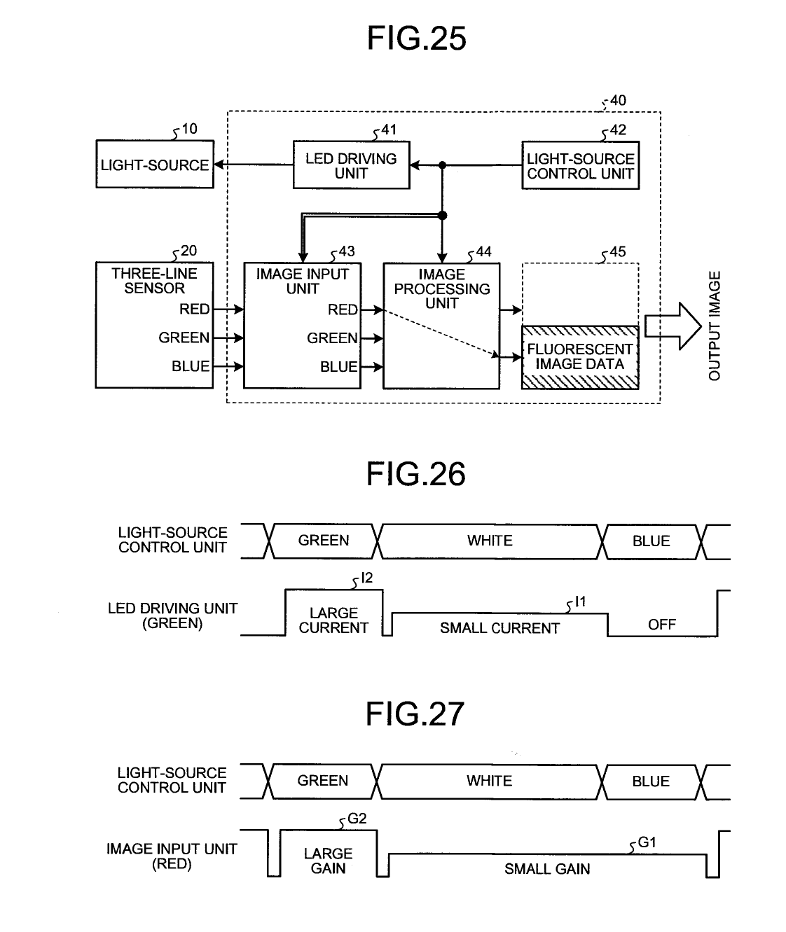

A fourth embodiment of the present invention will be described with reference to FIGS. 25 to 27. In the fourth embodiment, only a difference from the above-mentioned embodiments will be described.

In the second embodiment, the second modified example, and the case (3) of the third embodiment as described above, the exposure time of the white light source is lengthened and the exposure time of each of the green LED 12 and the blue LED 13 is shortened accordingly. Therefore, in the present embodiment, a control to assuredly obtain an output of the fluorescent image data is performed. FIG. 25 is a block diagram of a main configuration of an image reading apparatus according to the present embodiment. The image input unit 43 of the present embodiment is able to variably adjust an amplifier gain (amplification factor). The light-source control unit 42 is able to output a control signal to the image input unit 43 to control the amplifier gain of the image input unit 43.

When the fluorescent region is to be read by lighting the green LED 12, the light-source control unit 42 performs at least one of a control to increase the amount of luminescence of the green LED 12 and a control to increase the amplifier gain of the image input unit 43, as the control to assuredly obtain the output of the fluorescent image data. FIG. 26 is a diagram for explaining the control to increase the amount of luminescence of the green LED 12. FIG. 27 is a diagram for explaining the control to increase the amplifier gain of the image input unit 43.

FIG. 26 illustrates the control to sequentially switch the light sources such that the green LED 12 is turned on, then the white light source is turned on (the red LED 11, the green LED 12, and the blue LED 13 are turned on simultaneously), and then the blue LED 13 is turned on in the light source 10 having the RGB three-color LED. When the green LED 12 is to be turned on solely to read the fluorescent region, the light-source control unit 42 controls the LED driving unit 41 to increase the amount of a current supplied to the green LED 12. A current value I2 at this time is larger than a current-carrying amount I1 of the green LED 12 at the time of irradiation with white light. Accordingly, outputs of line data with respect to the fluorescent region can be increased. The current value I2 is set only for a short time, so that it can be set to a value larger than, for example, a rated current.

Furthermore, as illustrated in FIG. 27, when the green LED 12 is to be turned on to read the fluorescent region, the light-source control unit 42 controls the image input unit 43 to increase the amplifier gain of the image input unit 43. A gain G2 at this time is larger than an amplifier gain G1 at the time of irradiation with white light or blue light. Therefore, outputs of line data with respect to the fluorescent region can be increased. Therefore, the exposure time when the white light source is lighting is lengthened, and the exposure time when the green LED 12 and the blue LED 13 are lighting is shortened accordingly. Consequently, even when illuminance of received light by the sensor varies between the reading of the fluorescent region and the reading of the normal image, it is possible to adjust each output data obtained after the A/D conversion by the image input unit 43 to have optimal brightness.

In the present embodiment, the control to assuredly obtain the output of the fluorescent image data is performed only when the green LED 12 is lighting; however, the control to assuredly obtain the output of the fluorescent image data can also be performed when the blue LED 13 is lighting in addition to when the green LED 12 is lighting. In other words, when the blue LED 13 is to be turned on solely to read the fluorescent, region, it is possible to perform the control to increase a current-carrying amount of the blue LED 13 compared to other lighting periods or perform the control to increase the amplifier gain of the image input unit 43 compared to the amplifier gain obtained when the white light or green light is lighting. Furthermore, the white light source is not limited by ones obtained by lighting the red LED 11, the green LED 12, and the blue LED 13 simultaneously. For example, a white LED can be employed as the white light source.

Moreover, it is explained that the image input unit 43 amplifies an analog output from each of the sensors 21, 22, and 23; however, the image input unit 43 can be configured to amplify a digital output obtained by performing A/D conversion on the analog output.

### Fifth Embodiment

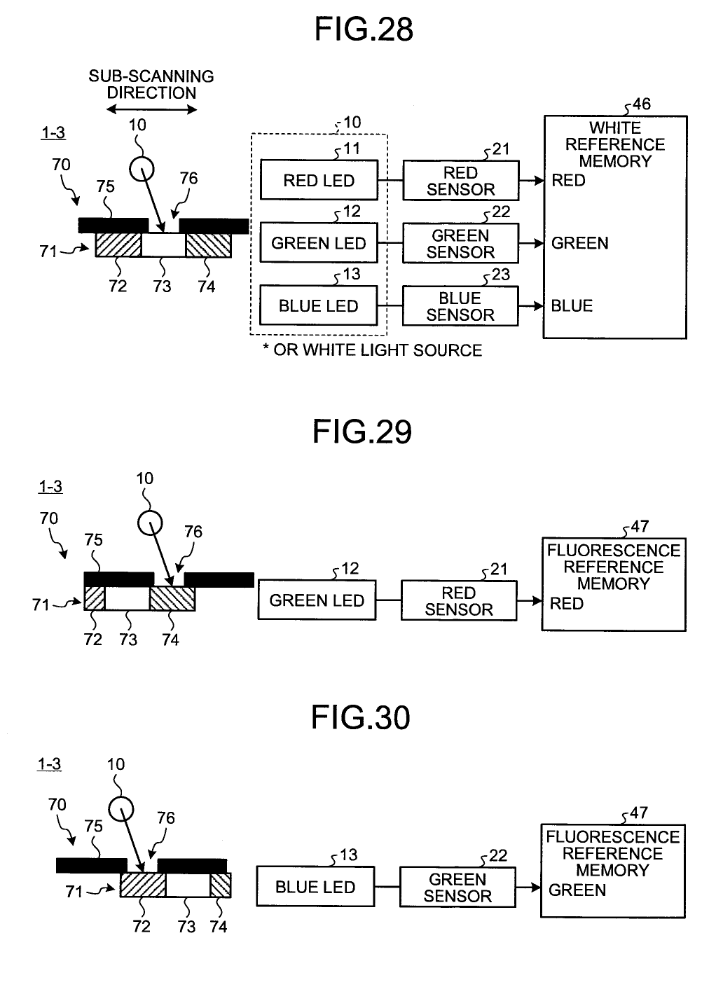

A fifth embodiment of the present invention will be described with reference to FIGS. 28 to 30. In the fifth embodiment, only a difference from the above-mentioned embodiments will be described.

In the present embodiment, shading correction is performed on the fluorescent image data. The shading correction is performed for reducing effects of luminance distribution of the light source in the main-scanning direction or effects of variation in imaging devices of an imaging sensor. In the shading correction, an output from each color sensor of the three-line sensor 20 is corrected by using reference data based on the luminance distribution in the main-scanning direction.

When the shading correction is performed on the fluorescent image data, it is not preferable to use a white reference for the normal image. The reason is as follows.

Illuminance distribution of the light source may vary. For example, in the above-mentioned second embodiment, when the normal image is to be read, the normal image is generated based on the outputs from the sensors 21, 22, and 23 when all the red LED 11, the green LED 12, and the blue LED 13 are lighting (when white light is applied). At this time, a light source of light that enters the green sensor 22 is the green LED 12. On the other hand, when the fluorescent region is to be read and reading is performed by using the green sensor 22, only the blue LED 13 is turned on. Namely, a light source of light that enters the green sensor 22 is the blue LED. Therefore, the illuminance distribution of the light source varies from when the normal image is read to when the fluorescent region is read, so that proper shading correction cannot be performed when the white reference for the normal image is used.

Furthermore, when the fluorescent region is to be read (e.g., when the fluorescent region is to be read by the green sensor 22 by irradiation with the blue LED 13), almost all excitation light (blue light) is cut out by the filter of the green sensor 22. Therefore, an output from a white reference plate according to a combination of the light source for reading the fluorescent region and the sensor becomes smaller than an output from the white reference plate according to a combination of the light source for reading the normal image and the sensor.

For these reasons, it is preferable to set a white reference for each of the normal image and the fluorescent region. In the present embodiment, a white (fluorescent) reference plate and a white (fluorescent) reference memory are provided for each of the normal image and the fluorescent region.

FIG. 28 is a diagram illustrating a method for setting a white reference for the normal image by an image reading apparatus 1-3 of the present embodiment. In FIG. 28, a code 70 denotes a reference plate. The reference plate 70 includes a reference plate body 71 and a shielding plate 75. The reference plate 70 is mounted at the same position as the white reference plate 2 of the above-mentioned first embodiment (see FIG. 1).

The reference plate body 71 includes a first fluorescence reference plate 72, a white reference plate 73, and a second fluorescence reference plate 74. The first fluorescence reference plate 72 provides a fluorescence reference for the fluorescent region that emits green fluorescence upon reception of light applied from the blue LED 13. The first fluorescence reference plate 72 is formed by resin mixed with fluorescent dye or is formed by applying yellow fluorescent coating (fluorescent material) on a surface to be irradiated with light, so that the first fluorescence reference plate 72 emits fluorescence similarly to a yellow fluorescent pen. The second fluorescence reference plate 74 provides a fluorescence reference for the fluorescent region that emits red fluorescence upon reception of light emitted from the green LED 12. The second fluorescence reference plate 74 is formed by resin mixed with fluorescent dye or is formed by applying pink fluorescent coating on a surface to be irradiated with light, so that the second fluorescence reference plate 74 emits fluorescence similarly to a pink fluorescent pen. The white reference plate 73 provides a reference for white used when applying white light, and can be formed similarly to those conventionally known.

The first fluorescence reference plate 72, the white reference plate 73, and the second fluorescence reference plate 74 are arranged adjacent to one another in the sub-scanning direction, and located in a range corresponding to the conveying path of the original S in the main-scanning direction (in a depth direction of the figure). The reference plate body 71 is movable in the conveying direction of the original (in the sub-scanning direction), and is moved in the sub-scanning direction by a moving unit not illustrated. The shielding plate 75 is arranged parallel to the reference plate body 71 at a location between the light source 10 and the reference plate body 71, and is able to shield the reference plate body 71 against light emitted from the light source 10. A slit-shape hole 76 extending in the main-scanning direction is formed on the shielding plate 75. The width of the hole 76 in the sub-scanning direction is thinner than the width of the white reference plate 73 in the sub-scanning direction. Therefore, the hole 76 is able to selectively apply light emitted from the light source 10 to one of the first fluorescence reference plate 72, the white reference plate 73, and the second fluorescence reference plate 74. Furthermore, a range of arrangement of the hole 76 in the main-scanning direction corresponds to the width of the conveying path of the original S, so that light from the light source 10 is reflected by the reference plate body 71 at least in a range corresponding to the width of the original S in the main-scanning direction, and then the light enters the three-line sensor 20.

When the white reference for the normal image is to be set, the moving unit of the reference plate 70 moves the reference plate body 71 so that a position of the white reference plate 73 and the position of the hole 76 correspond to each other in the sub-scanning direction. Accordingly, light emitted from the light source 10 is reflected by the white reference plate 73 and then enters the three-line sensor 20. Furthermore, the first fluorescence reference plate 72 and the second fluorescence reference plate 74 are shielded against the light from the light source 10 by the shielding plate 75. When the white reference for the normal image is to be set, all the red LED 11, the green LED 12, and the blue LED 13 are turned on in the light source 10. The control unit 40 includes a white reference memory for storing the white reference. In a white reference memory 46, an output (luminance distribution) from the red sensor 21 is stored as white reference data for the red LED 11, an output (luminance distribution) from the green sensor 22 is stored as white reference data for the green LED 12, and an output (luminance distribution) from the blue sensor 23 is stored as white reference data for the blue LED 13. When the normal image of the original S is to be read, the shading correction is performed on each output from the sensors 21, 22, and 23 based on each white reference data stored in the white reference memory 46.

FIG. 29 is a diagram illustrating a method for setting a fluorescence reference for the green LED 12. The control unit 40 includes a fluorescence reference memory 47 for storing the fluorescence reference. When the fluorescence reference for the green LED 12 is to be set, the moving unit moves the reference plate body 71 so that the position of the second fluorescence reference plate 74 and the position of the hole 76 correspond to each other in the sub-scanning direction. Accordingly, light emitted from the light source 10 is applied to the second fluorescence reference plate 74 and then fluorescence emitted from the second fluorescence reference plate 74 enters the three-line sensor 20. Furthermore, the first fluorescence reference plate 72 and the white reference plate 73 are shielded against the light from the light source 10 by the shielding plate 75. When the fluorescence reference for the green LED 12 is to be set, the green LED 12 is turned on. An output (luminance distribution) from the red sensor 21 at this time is stored in the fluorescence reference memory 47 as the fluorescence reference data of the green LED 12. When the fluorescent region of the original S is to be read, the shading correction is performed on the output from the red sensor 21 based on the fluorescence reference data of the green LED 12.

FIG. 30 is a diagram illustrating a method for setting a fluorescence reference for the blue LED 13. When the fluorescence reference for the blue LED 13 is to be set, the moving unit moves the reference plate body 71 so that the position of the first fluorescence reference plate 72 and the position of the hole 76 correspond to each other in the sub-scanning direction. Accordingly, the light emitted from the light source 10 is applied to the first fluorescence reference plate 72 and then fluorescence emitted from the first fluorescence reference plate 72 enters the three-line sensor 20. Furthermore, the white reference plate 73 and the second fluorescence reference plate 74 are shielded against the light from the light source 10 by the shielding plate 75. When the fluorescence reference for the blue LED 13 is to be set, the blue LED 13 is turned on. An output (luminance distribution) from the green sensor 22 at this time is stored in the fluorescence reference memory 47 as fluorescence reference data for the blue LED 13. When the fluorescent region of the original S is to be read, the shading correction is performed on the output from the green sensor 22 based on the fluorescence reference data of the blue LED 13.

According to the present embodiment, each output from the green LED 12 and the blue LED 13 is corrected based on the fluorescence reference data set for the fluorescent region. Consequently, fluorescent image can be generated without unevenness, sensitivity of the fluorescence identification can be increased, and decrease in precision of the fluorescence identification can be prevented.

In the present embodiment, an example is used in which the light source 10 is employed for setting the white reference and the fluorescence reference and performing the correction based on the references; however, it is possible to employ the light source 50 of the first modified example of the second embodiment for setting the white reference and the fluorescence reference and performing the correction based on the references.

According to an embodiment of the present invention, the fluorescent-image-data generating unit generates fluorescent image data based on predetermined color data corresponding to a second wavelength range obtained when a predetermined light source is turned on. Because the fluorescent image data are generated based on light of the second wavelength range different from irradiated light of a first wavelength range, it is possible to identify a fluorescent region with high sensitivity while preventing effects of light such as reflected light of the first wavelength range.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An image reading apparatus that generates color image data from an image on a medium to be read, based on R-color data, G-color data, and B-color data, the image reading apparatus comprising:
an irradiating unit that irradiates light to the medium;
an imaging unit that includes an R-color imaging member that outputs the R-color data based on received light from the medium to which the light has been irradiated by the irradiating unit, a G-color imaging member that outputs the G-color data based on the received light, and a B-color imaging member that outputs the B-color data based on the received light;
a predetermined light source that irradiates to the medium first light of a first visible wavelength range different from R-color; and
a fluorescent-image-data generating unit that generates fluorescent image data of a fluorescent region contained in the image, based on predetermined color data corresponding to second light of a second visible wavelength range different from the first visible wavelength range, the second light being generated by the fluorescent region when the predetermined light source is turned on and the fluorescent region receives the first light from the predetermined light source.

2. The image reading apparatus according to claim 1, wherein
the predetermined light source comprises at least one of a G-color light source that irradiates G-color light and a B-color light source that irradiates B-color light, and
the fluorescent-image-data generating unit generates the fluorescent image data based on the R-color data obtained when the G-color light source is turned on, or the G-color data obtained when the B-color light source is turned on.

3. The image reading apparatus according to claim 2, wherein
the irradiating unit comprises a white light source that irradiates white light to the medium, and
the color image data is generated based on the R-color data, the G-color data, and the B-color data obtained when the white light source irradiates the white light.

4. The image reading apparatus according to claim 3, wherein the white light source is provided independently of the predetermined light source.

5. The image reading apparatus according to claim 3, wherein
the irradiating unit comprises an R-color light source that irradiates R-color light, and the G-color and B-color light sources which are the predetermined light source, and
the R-color light source, the G-color light source, and the B-color light source are simultaneously turned on as the white light source to generate the color image data.

6. The image reading apparatus according to claim 3, wherein
generation of the color image data by turning on the white light source is performed independently of generation of the fluorescent image data by turning on the predetermined light source, and
an exposure time of the imaging unit upon turning on the white light source for generating the color image data is longer than an exposure time of the imaging unit upon turning on the predetermined light source for generating the fluorescent image data.

7. The image reading apparatus according to claim 6, further comprising an amplifying unit that amplifies an analog output from the imaging unit, wherein
the color image data and the fluorescent image data are generated based on color data amplified by the amplifying unit, and
an amplification factor for the analog output when the color image data are generated by turning on the white light source is larger than an amplification factor for the analog output when the fluorescent image data are generated by turning on the predetermined light source.

8. The image reading apparatus according to claim 2, wherein
the irradiating unit comprises an R-color light source that irradiates R-color light, the G-color light source, and the B-color light source,
the R-color light source, the G-color light source, and the B-color light source are each turned on solely, and
the color image data is generated based on the R-color data obtained when the R-color light source is turned on, the G-color data obtained when the G-color light source is turned on, and the B-color data obtained when the B-color light source is turned on.

9. The image reading apparatus according to claim 1, further comprising a reference plate that is located in a main-scanning direction of the imaging unit, and generates light of the second visible wavelength range upon reception of light of the first visible wavelength range, wherein the predetermined color data obtained by irradiating the light of the first visible wavelength range to the medium is corrected based on the predetermined color data obtained by irradiating the light of the first visible wavelength range to the reference plate by the predetermined light source.
